(19) United States
(12) Patent Application Publication
(10) Pub. No.: US 2026/0245260 A1
(43) Pub. Date: Aug. 20, 2026

(54) Local Quality Parameters for Coding Point Cloud Geometry

(71) Applicant: Ofinno, LLC, Reston, VA (US)

(72) Inventors: Sébastien Lasserre, Thorigné-Fouillard (FR); Jonathan Taquet, Talensac (FR)

(73) Assignee: Ofinno, LLC, Reston, VA (US)

(21) Appl. No.: 19/647,112

(22) Filed: Apr. 14, 2026

Related U.S. Application Data
(63) Continuation of application No. PCT/US2024/051314, filed on Oct. 15, 2024.
(60) Provisional application No. 63/544,162, filed on Oct. 14, 2023.

(51) Int. Cl. G06T 9/40; G06T 17/00

(52) U.S. Cl. CPC G06T 9/40; G06T 17/00; G06T 2210/56

(57) ABSTRACT

A coder decodes, from a bitstream, quality unit information indicating: an occupancy tree representing a partition of a volume of a point cloud geometry, and quality units corresponding to nodes of the occupancy tree. Based on the occupancy tree, an occupied quality unit is from the quality units. The occupied quality unit contains a portion of the point cloud geometry and corresponds to a set of occupied leaf nodes of the occupancy tree. Positions of triangle vertices of the set of occupied leaf nodes are decoded from the bitstream. The coder dequantizes the positions of triangle vertices based on at least one local quality parameter associated with the occupied quality unit. The coder reconstructs the portion of the point cloud geometry based on the dequantized positions of triangle vertices.

### CROSS-REFERENCE TO RELATED APPLICATIONS

This application is a continuation of International Application No. PCT/US2024/051314, filed Oct. 15, 2024, which claims the benefit of U.S. Provisional Application No. 63/544,162, filed Oct. 14, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary point cloud coding/decoding system in which embodiments of the present disclosure may be implemented.

FIG. 2 illustrates the Morton order of eight sub-cuboids split from a cuboid.

FIG. 3 illustrates an example processing or scanning order for the first three level of an occupancy tree.

FIG. 4 illustrates an example of already-coded occupancies of cuboids that may be used to code the occupancy of a current child cuboid.

FIG. 5 illustrates an example of a dynamic reduction function DR that may be used in dynamic OBUF.

FIG. 6 illustrates a flowchart of an example method for coding the occupancy (e.g., as indicated by a single bit) of a current child cuboid using dynamic OBUF.

FIG. 7 illustrates an example of an occupied cube of size N×N×N (where N>1) that corresponds to a TriSoup node of an occupancy tree.

FIG. 8A illustrates an example cube corresponding to a TriSoup node with a number K of TriSoup vertices Vₖ.

FIG. 8B illustrates an example refinement to the TriSoup model by coding a centroid residual vector Cᵣₑₛ into the bitstream such as to use C+Cᵣₑₛ instead of C as pivoting vertex for the triangles.

FIG. 8C illustrates an example of coding a centroid residual vector Cᵣₑₛ in/from the bitstream such that an adjusted centroid C+Cᵣₑₛ is used instead of centroid C for generating TriSoup triangles of a cuboid corresponding to a portion of a point cloud, according to some embodiments.

FIG. 9A and FIG. 9B illustrate examples of voxelization.

FIG. 9C illustrates an example of the halo technique in a halo extending from one or more edges of a TriSoup triangle is determined to extend the TriSoup triangle, according to some embodiments.

FIG. 9D illustrates an example of enhancing voxelization of a TriSoup triangle by adding one or more points based on a point determined to be in the TriSoup triangle (i.e., also referred to as applying the “thickness” of TriSoup triangles technique), according to some embodiments.

FIG. 10A illustrates an example process for encoding in a bitstream a point cloud geometry using a TriSoup geometry scheme, according to some embodiments.

FIG. 10B illustrates another example process for encoding a point cloud geometry using a TriSoup geometry scheme, according to some embodiments.

FIG. 11A illustrates an example process for decoding a point cloud geometry using a TriSoup geometry scheme, according to some embodiments.

FIG. 11B illustrates another example process for decoding a point cloud geometry using a TriSoup geometry scheme, according to some embodiments.

FIG. 12A, FIG. 12B, and FIG. 12C illustrate an example of a replacement of a TriSoup triangle belonging to a TriSoup node 1200, according to some embodiments.

FIG. 13A and FIG. 13B illustrate an example of a replacement of a pair of TriSoup triangles belonging to two TriSoup nodes, according to some embodiments.

FIG. 14 illustrates an example of a replacement of a pair of TriSoup triangles belonging to two TriSoup nodes, according to some embodiments.

FIG. 15 illustrates an example of iterative replacement of TriSoup triangles, according to some embodiments.

FIG. 16A illustrates an example of quality units that partition a volume encompassing a point cloud geometry, according to some embodiments.

FIG. 16B illustrates an example of occupied quality units corresponding to the quality units of FIG. 16A, according to some embodiments.

FIG. 17 illustrates an example of occupied quality units obtained from an occupancy tree, according to some embodiments.

FIG. 18A illustrates an example process for encoding in a bitstream a point cloud geometry, according to some embodiments.

FIG. 18B illustrates an example process for encoding in a bitstream a point cloud geometry, according to some embodiments.

FIG. 19A illustrates an example process for decoding from a bitstream a point cloud geometry, according to some embodiments.

FIG. 19B illustrates an example process for decoding from a bitstream a point cloud geometry, according to some embodiments.

FIG. 20 illustrates an example of an occupied quality unit corresponding to occupied non-leaf nodes at a tree level L_{qual} of an occupancy tree and to occupied non-leaf nodes at a deeper tree level L_{qual}+1, according to some embodiments.

FIG. 21 illustrates a flowchart of an example method for encoding in a bitstream a point cloud geometry, according to some embodiments.

FIG. 22 illustrates a flowchart of an example method for decoding from a bitstream a point cloud geometry, according to some embodiments.

FIG. 23 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of points that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color, reflectance, time stamp, etc. Compared to traditional visual data, volumetric visual data may provide a more immersive way to experience visual data.

For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Sparse volumetric visual data may be used in the automotive industry for the representation of 3D maps (cartography) or as input to assisted driving systems. In the latter use case, volumetric visual data is typically input to driving decision algorithms. In another example, volumetric visual data may be used to store valuable objects in digital form. In applications for preserving cultural heritage, the goal is to keep a representation of objects that may be threatened by natural disasters. For example, statues, vases, and temples may be entirely scanned and stored as volumetric visual data having several billions of samples. This use case for volumetric visual data may be particularly relevant for valuable objects in locations where earthquakes, tsunamis, and typhoons are frequent. Volumetric visual data may be in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is point clouds. A point cloud comprises a collection of points in three-dimensional (3D) space. Each point in a point cloud may comprise geometry information that indicates the point's position in 3D space. For example, the geometry information may indicate the point's position in 3D space using three Cartesian coordinates (x, y, and z) or using spherical coordinates (r, phi, theta) (e.g., when acquired by a rotating sensor). The positions of points in a point cloud may be quantized according to a space precision, which may be the same or different in each dimension. The quantization process may create a grid in 3D space. One or more points residing within each sub-grid volume may be mapped to the sub-grid center coordinates, referred to as voxels. A voxel (also referred to as a volumetric pixel) may be considered as a 3D extension of pixels corresponding to the 2D image grid coordinates. For example, similar to a pixel being the smallest unit when dividing the 2D space (or 2D image) into discrete, uniform (e.g., equally sized) regions, a voxel may be the smallest unit of volume when dividing 3D space into discrete, uniform regions. The sub-grid center coordinates (which correspond to voxels) may be referred to as a voxelized grid. A point in a point cloud may further comprise one or more types of attribute information. Attribute information may indicate a property of a point's visual appearance. For example, attribute information may indicate a texture (e.g., color) of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). In another example, a point in a point cloud may comprise light field data in the form of multiple view-dependent texture information. Light field data may be another type of optional attribute information.

The points in a point cloud may describe an object or a scene. For example, the points in a point cloud may describe the external surface and/or the internal structure of an object or scene. The object or scene may be synthetically generated by a computer or may be generated from the capture of a real-world object or scene. The geometry information of a real-world object or scene may be obtained by 3D scanning and/or photogrammetry. 3D scanning may include laser scanning, structured light scanning, and/or modulated light scanning. 3D scanning may obtain geometry information by moving one or more laser heads, structured light cameras, and/or modulated light cameras relative to an object or scene being scanned. Photogrammetry may obtain geometry information by triangulating the same feature or point in different spatially shifted 2D photographs. Point cloud data may be in the form of a point cloud frame that describes an object or scene captured at a particular time instance or in the form of a sequence of point cloud frames (referred to as a point cloud sequence or point cloud video) that describes an object or scene captured at multiple different time instances.

The data size of a point cloud frame or sequence may be too large for storage and/or transmission in many applications. For example, a single point cloud may comprise over a million points or even billions of points, where each point may comprise geometry information and one or more optional types of attribute information. The geometry information of each point may comprise three Cartesian coordinates (x, y, and z) or spherical coordinates (r, phi, theta) that are each represented, for example, using at least 10 bits per component or 30 bits in total. The attribute information of each point may comprise a texture corresponding to three color components (e.g., R, G, and B color components) that are each represented, for example, using 8-10 bits per component or 24-30 bits in total. A single point therefore comprises at least 54 bits of information in this example, with at least 30 bits of geometry information and at least 24 bits of texture. If a point cloud frame includes a million such points, each point cloud frame would require 54 million bits or 54 megabits to represent. In case of dynamic point clouds that change over time, at a frame rate of 30 frames per second, a data rate of 1.62 gigabits per second would be required to transmit the points of the point cloud sequence. Therefore, raw representations of point clouds may require a large amount of data and the practical deployment of point-cloud-based technologies may need compression technologies that enable the storage and distribution of point clouds with reasonable cost.

Encoding may be used to compress and/or reduce the data size of a point cloud frame or sequence to provide for more efficient storage and/or transmission. Decoding may be used to decompress a compressed point cloud frame or sequence for display and/or other forms of consumption (e.g., by a machine learning-based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, like medical applications or autonomous driving, may require lossless compression to avoid altering the results of a decision obtained based on the analysis of the transmitted and decompressed point cloud frame.

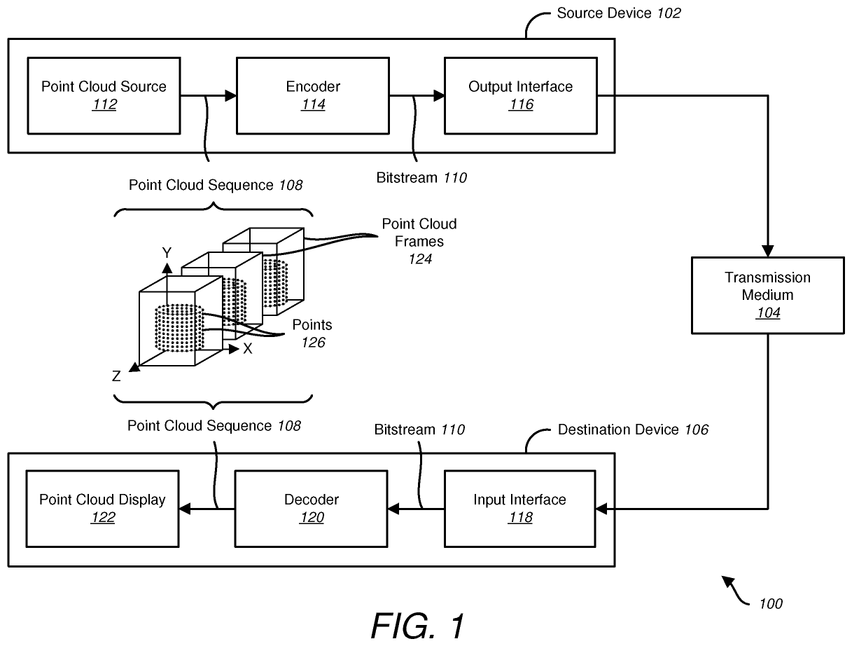

FIG. 1 illustrates an exemplary point cloud coding system 100 in which embodiments of the present disclosure may be implemented. Point cloud coding system 100 comprises a source device 102, a transmission medium 104, and a destination device 106. Source device 102 encodes a point cloud sequence 108 into a bitstream 110 for more efficient storage and/or transmission. Source device 102 may store and/or transmit bitstream 110 to destination device 106 via transmission medium 104. Destination device 106 decodes bitstream 110 to display point cloud sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming counsel) or may be fully self-contained.

To encode point cloud sequence 108 into bitstream 110, source device 102 may comprise a point cloud source 112, an encoder 114, and an output interface 116. Point cloud source 112 may provide or generate point cloud sequence 108 from a capture of a natural scene and/or a synthetically generated scene. A synthetically generated scene may be a scene comprising computer generated graphics. Point cloud source 112 may comprise one or more point cloud capture devices (e.g., one or more laser scanning devices, structured light scanning devices, modulated light scanning devices, and/or passive scanning devices), a point cloud archive comprising previously captured natural scenes and/or synthetically generated scenes, a point cloud feed interface to receive captured natural scenes and/or synthetically generated scenes from a point cloud content provider, and/or a processor to generate synthetic point cloud scenes.

As shown in FIG. 1, a point cloud sequence 108 may comprise a series of point cloud frames 124. A point cloud frame may describe an object or scene captured at a particular time instance. Point cloud sequence 108 may achieve the impression of motion when a constant or variable time is used to successively present point cloud frames 124 of point cloud sequence 108. A point cloud frame may comprise a collection of points 126 in 3D space. Each of points 126 may comprise geometry information that indicates the point's position in 3D space. For example, the geometry information may indicate the point's position in 3D space using three Cartesian coordinates (x, y, and z). One or more of points 126 may further comprise one or more types of attribute information. Attribute information may indicate a property of a point's visual appearance. For example, attribute information may indicate a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying). In another example, one or more of points 126 may comprise light field data in the form of multiple view-dependent texture information. Light field data may be another type of optional attribute information. Color attribute information of one or more of points 126 may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

Encoder 114 may encode point cloud sequence 108 into bitstream 110. To encode point cloud sequence 108, encoder 114 may apply one or more lossy compression techniques and/or prediction techniques to reduce redundant information in point cloud sequence 108. Redundant information is information that may be predicted at a decoder and therefore may not be needed to be transmitted to the decoder for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization by quantizing positions of points in a point cloud, which creates a grid in 3D space. The G-PCC reference software encoder may map the points to the center coordinates of the sub-grid volume (or voxel) that their quantized locations reside. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may apply a transform tool, such as Region Adaptive Hierarchical Transform (RAHT), the Predicting Transform, and/or the Lifting Transform. The Lifting Transform may be built on top of the Predicting Transform but with an extra update/lifting step. Consequently, these two transforms may be referred to as Predicting/Lifting Transform or pred lift. Encoder 114 may operate in a same or similar manner to an encoder provided by the G-PCC reference software.

Output interface 116 may be configured to write and/or store bitstream 110 onto transmission medium 104 for transmission to destination device 106. In addition, or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into point cloud sequence 108 for display or other forms of consumption, destination device 106 may comprise an input interface 118, a decoder 120, and a point cloud display 122. Input interface 118 may be configured to read bitstream 110 stored on transmission medium 104 by source device 102. In addition, or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode point cloud sequence 108 from encoded bitstream 110. For example, decoder 120 may operate in a same or similar manner to a decoder provided by G-PCC reference software. In some examples, decoder 120 may decode a point cloud sequence that approximates point cloud sequence 108 due to, for example, lossy compression of point cloud sequence 108 by encoder 114 and/or errors introduced into encoded bitstream 110 during transmission to destination device 106.

Point cloud display 122 may display point cloud sequence 108 to a user. Point cloud display 122 may comprise a cathode rate tube (CRT) display, a liquid crystal display (LCD), a plasma display, a light emitting diode (LED) display, a 3D display, a holographic display, a head mounted display, or any other display device suitable for displaying point cloud sequence 108.

It should be noted that point cloud coding/decoding system 100 is presented by way of example and not limitation. In the example of FIG. 1, point cloud coding/decoding system 100 may have other components and/or arrangements. For example, point cloud source 112 may be external to source device 102. Similarly, point cloud display 122 may be external to destination device 106 or omitted altogether where point cloud sequence is intended for consumption by a machine and/or storage device. In another example, source device 102 may further comprise a point cloud decoder and destination device 106 may comprise a point cloud encoder. In such an example, source device 102 may be configured to further receive an encoded bit stream from destination device 106 to support two-way point cloud transmission between the devices.

As mentioned above, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel (or a volumetric pixel). A voxel may be considered as a 3D extension of pixels corresponding to 2D image grid coordinates.

The encoder may represent or code the point cloud using an occupancy tree. For example, the encoder may split the initial volume or cuboid (also referred to as a bounding box) containing the point cloud into sub-cuboids. The encoder may then recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied cuboid into, for example, two sub-cuboids (to form a binary tree), four sub-cuboids (to form a quadtree), or eight sub-cuboids (to form an octree). The encoder may split an occupied cuboid to obtain sub-cuboids all with the same size and shape at a given depth level of the occupancy tree by splitting following a plane passing through the middle of edges of the cuboid.

The initial volume or cuboid containing the point cloud may correspond to the root node of the occupancy tree. Each occupied sub-cuboid, split from the initial volume/cuboid, may correspond to a node (of the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, a maximum depth level of the occupancy tree is reached or each occupied sub-cuboid has a volume corresponding to one voxel.

Each non-leaf node of the occupancy tree may comprise or be associated with an occupancy word representing an occupancy state of the cuboid corresponding to the node. For example, a node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be represented or indicated by a binary value of 1 in the 1-byte occupancy word and unoccupied sub-cuboids may be represented or indicated by a binary value of 0 in the 1-byte occupancy word. In other examples, occupied and un-occupied sub-cuboids may be represented or indicated by opposite 1-bit binary values in the 1-byte occupancy word.

Each bit of an occupancy word may represent or indicate the occupancy of a different one of the eight sub-cuboids following the so-called Morton order. For example, the least significant bit of an occupancy word may represent or indicate the occupancy of a first one of the eight sub-cuboids following the Morton order, the second least significant bit of an occupancy word may represent or indicate the occupancy of a second one of the eight sub-cuboids following the Morton order, etc.

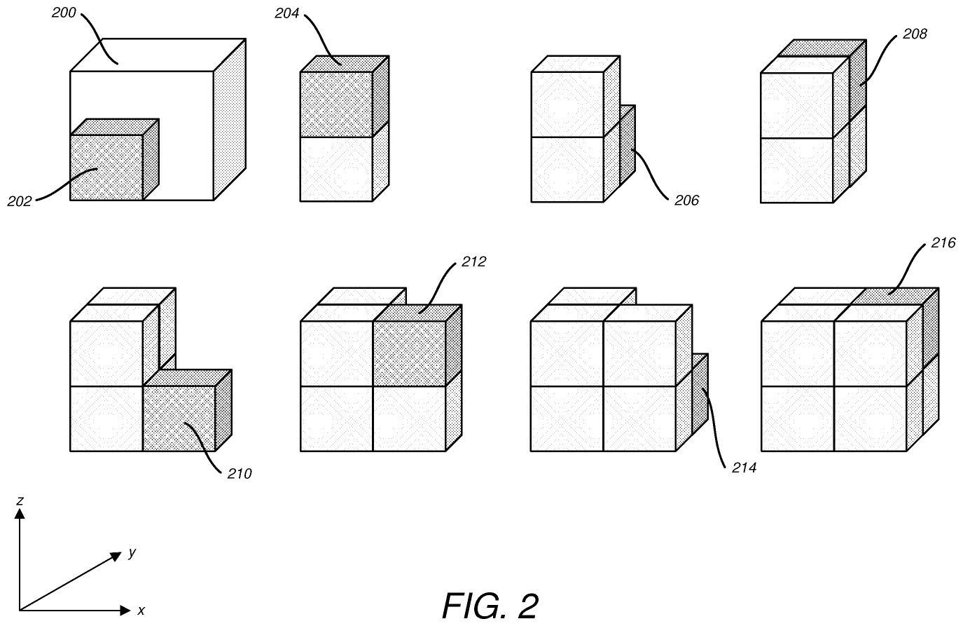

FIG. 2 illustrates the Morton order of eight sub-cuboids 202-216 split from a cuboid 200. Sub-cuboids 202-216 are labeled based on their Morton order, with child node 202 being the first in Morton order and child node 216 being the last in Morton order. The Morton order for sub-cuboids 202-216 is a local lexicographic order in xyz.

The geometry of the point cloud is represented by, and therefore may be determined from, the initial volume and the occupancy words of the nodes in the occupancy tree. The encoder may therefore transmit the initial volume and the occupancy words of the nodes in the occupancy tree in a bitstream to a decoder for reconstructing the point cloud. Before transmitting the initial volume and the occupancy words of the nodes in the occupancy tree, the encoder may entropy encode the occupancy words. For example, the encoder may encode an occupancy bit of an occupancy word of a node corresponding to a cuboid, based on one or more occupancy bits of occupancy words of other nodes corresponding to cuboids that are adjacent or spatially close to the cuboid of the occupancy bit being encoded.

An encoder and/or decoder may code occupancy bits of occupancy words in sequence of a scan order. For example, an encoder and/or decoder may scan an occupancy tree in breadth-first order: all the occupancy words of the nodes of a given depth (or level) within the occupancy tree may be scanned before scanning the occupancy words of the nodes of the next depth (or level). Within a depth, the encoder and/or decoder may scan the occupancy words of nodes in the Morton order. Within a node, the encoder and/or decoder may scan the occupancy bits of the occupancy word of the node further in the Morton order.

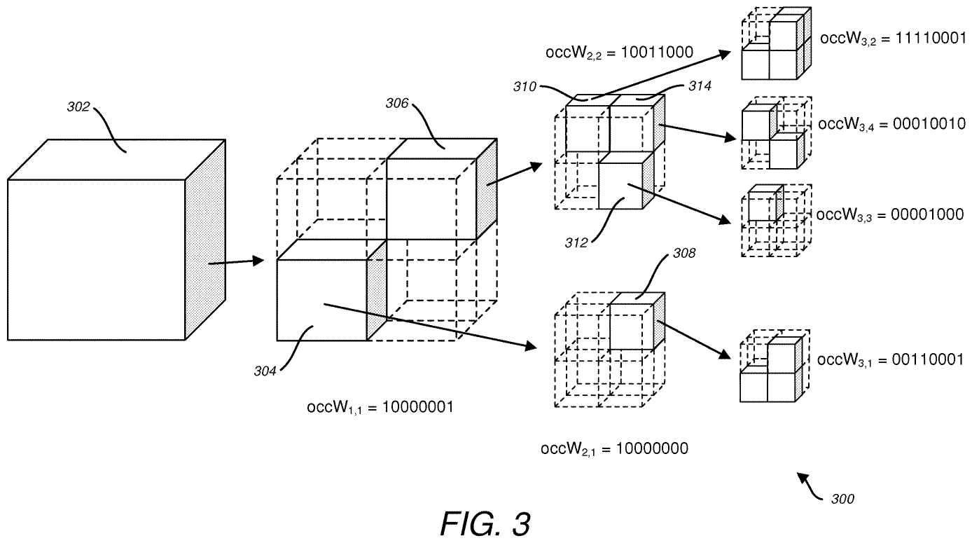

FIG. 3 illustrates an example of this scanning order for the first three levels of an occupancy tree 300. In FIG. 3, a cube 302 corresponding to the root node of occupancy tree 300 is divided into eight sub-cubes. Two sub-cubes 304 and 306 of the eight sub-cubes are occupied, while the other six sub-cubes are unoccupied. Following the Morton order, a first eight-bit occupancy word occW_{1,1} is constructed to represent the occupancy word of the root node. The least significant occupancy bit of the first eight-bit occupancy word occW_{1,1} represents or indicates the occupancy of the first sub-cube of the eight sub-cubes in Morton order, the second least significant occupancy bit of the first eight-bit occupancy word occW_{1,1} represents or indicates the occupancy of the second sub-cube of the eight sub-cubes in Morton order, etc.

Each of the two occupied sub-cubes 304 and 306 corresponds to a node off the root node in a second level of occupancy tree 300. The two occupied sub-cubes 304 and 306 are each further split into eight sub-cubes. One of the sub-cubes 308 of the eight sub-cubes split from sub-cube 304 is occupied, while the other seven sub-cubes are unoccupied. Three of the sub-cubes 310, 312, and 314 of the eight sub-cubes split from sub-cube 306 are occupied, while the other five sub-cubes of the eight sub-cubes split from sub-cube 306 are unoccupied. Two second eight-bit occupancy words occW_{2,1} and occW_{2,2} are constructed in this order to respectively represent the occupancy word of the node corresponding to sub-cube 304 and the occupancy word of the node corresponding to sub-cube 306.

Each of the four occupied sub-cubes 308, 310, 312, and 314 corresponds to a node in a third level of occupancy tree 300. The four occupied sub-cubes 308, 310, 312, and 314 are each further split into eight sub-cubes or 32 sub-cubes in total. Four third eight-bit occupancy words occW_{3,1}, occW_{3,2}, occW_{3,3} and occW_{3,4} are constructed in this order to respectively represent the occupancy word of the node corresponding to sub-cube 308, the occupancy word of the node corresponding to sub-cube 310, the occupancy word of the node corresponding to sub-cube 312, and the occupancy word of the node corresponding to sub-cube 314.

Following the scanning order discussed above, the occupancy words of this exemplary occupancy tree 300 may be entropy coded (e.g., entropy encoded by an encoder and entropy decoded by a decoder) as the succession of the seven occupancy words occW_{1,1} to occW_{3,4}. As a consequence of the breadth-first scanning order, when entropy coding the occupancy word of a current child node belonging to a current parent node, the occupancy words of all nodes having the same depth (or level) as the current parent node have already been entropy coded. In addition, the occupancy words of all nodes having the same depth (or level) as the current child node and having a lower Morton order than the current child node have also already been entropy coded. Part of these already coded occupancy words may be used to entropy code the occupancy word of the current child node. For example, the already coded occupancy words of neighboring parent and child nodes may be used to entropy code the occupancy word of the current child node. When entropy coding a particular occupancy bit of the occupancy word of the current child node, the occupancy bits of the occupancy word having a lower Morton order than the particular occupancy bit have also already been entropy coded and may be used to code the occupancy bit of the occupancy word of the current child node.

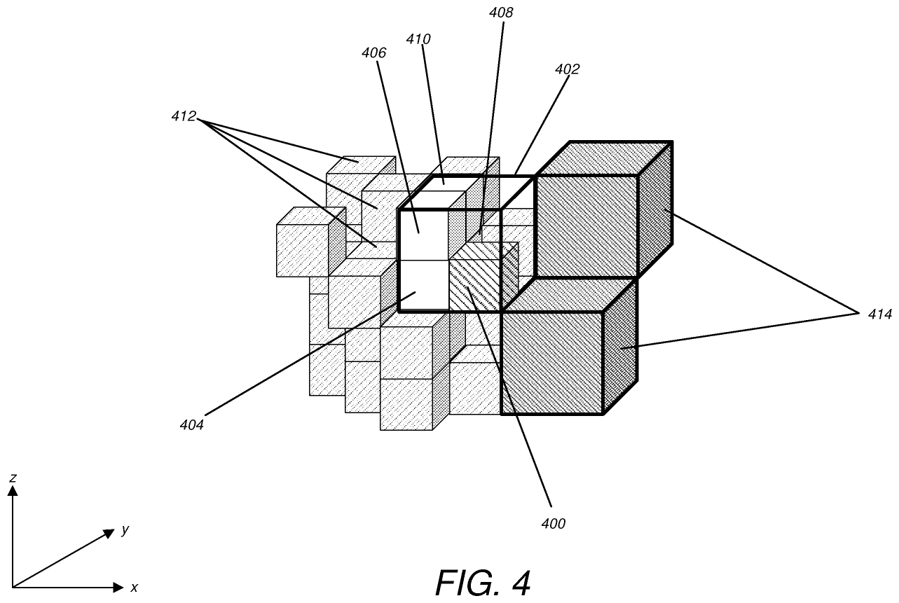

FIG. 4 illustrates an example neighborhood of cuboids with already-coded occupancy bits that may be used to entropy code the occupancy bit of a current child cuboid 400. The neighborhood of cuboids with already-coded occupancy bits may be determined based on the scanning order of an occupancy tree representing the geometry of the cuboids in FIG. 4 as discussed above. As illustrated in FIG. 4, current child cuboid 400 belongs to a current parent cuboid 402. Following the scanning order of the occupancy words and occupancy bits of nodes of the occupancy tree, the occupancy bits of four child cuboids 404, 406, 408, and 410, belonging to the same current parent cuboid 402, have already been coded. Also, the occupancy bit of child cuboids 412 of preceding parent cuboids have already been coded. Furthermore, the occupancy bits of parent cuboids 414, for which the occupancy bits of child cuboids have not already been coded, have already been coded. Therefore, the already-coded occupancy bits of cuboids 404, 406, 408, 410, 412, and 414 may be used to code the occupancy bit of the current child cuboid 400.

The number of possible occupancy configurations for a neighborhood of a current child cuboid may be 2N, where N is the number of cuboids in the neighborhood of the current child cuboid with already-coded occupancy bits. The neighborhood of the current child cuboid may comprise several dozens of cuboids, among them the 26 adjacent parent cuboids sharing a face, an, edge, or a vertex with the parent cuboid of the current child cuboid and also several adjacent child cuboids (with occupancy bits already coded) sharing a face, an edge, or a vertex with the current child cuboid. Even limited to a subset of the adjacent cuboids, the occupancy configuration for a neighborhood of the current child cuboid may have billions of possible occupancy configurations making its direct use impractical. The occupancy configuration for a neighborhood of the current child cuboid may be used by an encoder and/or decoder to select the context (or equivalently the probability model), among a set of contexts, of a binary entropy coder (e.g., binary arithmetic coder) that codes the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC)).

Several methods may be used by an encoder and/or decoder to reduce the occupancy configurations for a neighborhood of a current child cuboid being coded to a practical number of reduced occupancy configurations. Firstly, the 2⁶ or 64 occupancy configurations of the six adjacent parent cuboids sharing a face with the parent cuboid of the current child cuboid may be reduced to 9 occupancy configurations by using geometry invariance. Secondly, an occupancy score for the current child cuboid may be obtained from the 2²⁶ occupancy configurations of the 26 adjacent parent cuboids. The score may be further reduced into a ternary occupancy prediction (“predicted occupied”, “unsure”, “predicted unoccupied”) by applying score thresholds. Thirdly, the number of occupied and the number of unoccupied adjacent child cuboids may be used instead of the individual occupancies of these child cuboids.

An encoder and/or decoder employing one or more of the above methods may reduce the number of possible occupancy configurations for a neighborhood of a current child cuboid to a more manageable number (e.g., a few thousands). However, it has been observed that instead of associating a reduced number of contexts (or probability models) directly to the reduced occupancy configurations, another mechanism may be used, namely Optimal Binary Coders with Update on the Fly (OBUF). An encoder and/or decoder may implement OBUF to limit the number of contexts to a lower number (e.g., 32 contexts).

OBUF may use a limited number (e.g., 32) of contexts that may be fixed. These contexts may be ordered, referred to by a context index (e.g., a context index in the range of 0 to 31), and associated from a lowest virtual probability to a highest virtual probability to code a 1. A Look-Up Table (LUT) of context indices may be initialized at the beginning of a point cloud coding process. For example, the LUT may initially point to a context (e.g., context with context index 15), among the limited number of contexts, with the median virtual probability to code a 1 for all input. This LUT may take an occupancy configuration for a neighborhood of current child cuboid as input and output the context index associated with the occupancy configuration. Consequently, the LUT may have as many entries as reduced occupancy configurations (e.g., around a few thousand). The coding of the occupancy bit of a current child cuboid may follow the steps of determining the reduced occupancy configuration of the current child node, obtaining a context index by applying the reduced occupancy configuration as an entry to the LUT, coding the occupancy bit of the current child cuboid by using the context pointed to (or indicated) by the context index, and finally updating the LUT entry corresponding to the reduced occupancy configuration depending on the value of the coded occupancy bit of the current child cuboid. If a binary 0 (e.g., indicating the current child cuboid is unoccupied) is coded, the LUT entry may be decreased to a lower context index value, and if a binary 1 (e.g., indicating the current child cuboid is occupied) is coded, the LUT entry may be increased to a higher context index value. The update process of the context index may be based on a theoretical model of optimal distribution for virtual probabilities associated with the limited number of contexts. This virtual probability for a context may be fixed by a model and may be different from the internal probability of the context that evolves during the coding of bits of data. The evolution of the internal context may follow a well-known process similar to the process in CABAC.

An encoder and/or decoder may implement a “dynamic OBUF” scheme that may handle a much larger number of occupancy configurations for a neighborhood of a current child cuboid than can be handled by general OBUF, while maintaining complexity within reasonable bounds. The use of a larger number of occupancy configurations for a neighborhood of a current child cuboid may lead to improved compression capabilities. By using an occupancy tree compressed by OBUF, an encoder and/or decoder may reach a lossless compression performance as good as 1 bit per point (bpp) for coding the geometry of dense point clouds. An encoder and/or decoder may implement dynamic OBUF to potentially further reduce the bitrate by more than 25% to 0.7 bpp.

OBUF may not take as input a large variety of reduced occupancy configurations for a neighborhood of a current child cuboid, thus potentially leading to a loss of useful correlation. The size of the LUT of context indices may be increased to handle more various occupancy configurations for a neighborhood of a current child cuboid as input. However, by doing so, statistics may be diluted, and compression performance may be reduced. For example, if the LUT has millions of entries and the point cloud has a hundred thousand points, then most of the entries are never visited. Worse yet, many entries may be visited only a few times and their associated context indices may not be updated enough times to reflect any meaningful correlation between the occupancy configuration value and the probability of occupancy of the current child cuboid. Dynamic OBUF may be implemented to mitigate the dilution of statistics due to the increase in the number of occupancy configurations for a neighborhood of a current child cuboid. This mitigation is performed by a “dynamic reduction” of occupancy configurations in dynamic OBUF.

Dynamic OBUF may add an extra step of reduction of occupancy configurations for a neighborhood of a current child cuboid before applying the LUT of context indices. This step may be called a dynamic reduction because it evolves based on the progress of the coding of the point cloud or, more precisely, based on already visited occupancy configurations.

As discussed above, many possible occupancy configurations for a neighborhood of a current child cuboid are potentially involved but only a subset may be visited during the coding of a point cloud. This subset may characterize the type of the point cloud. For example, when coding AR or VR dense point clouds, most of the visited occupancy configurations may exhibit occupied adjacent cuboids of a current child cuboid. On the other hand, when coding sensor-acquired sparse point clouds, most of the visited occupancy configurations may exhibit only a few occupied adjacent cuboids of a current child cuboid. The role of the dynamic reduction may be to obtain a more precise correlation based on the most visited occupancy configuration while putting aside (or reducing aggressively) other occupancy configurations that are much less visited. The dynamic reduction may be updated on-the-fly, as detailed below, after each visit of an occupancy configuration during the coding of occupancy data.

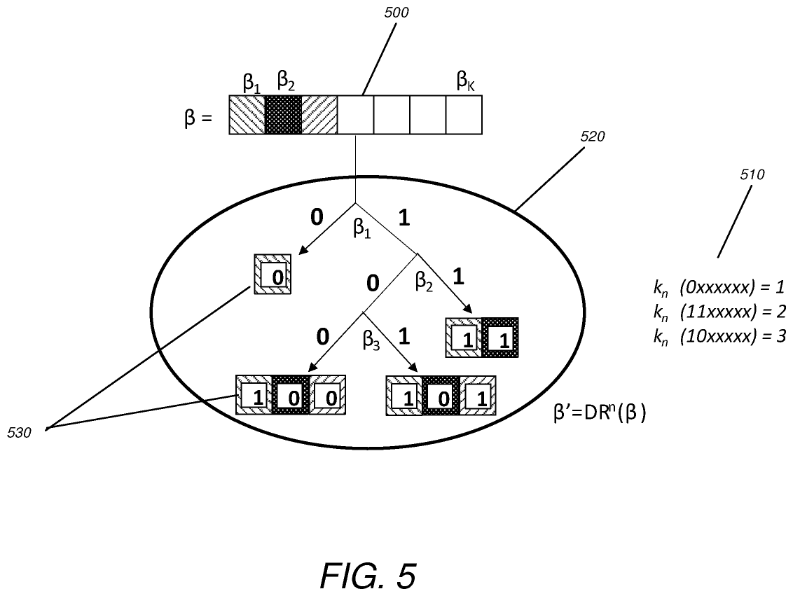

FIG. 5 illustrates an example of a dynamic reduction function DR that may be used in dynamic OBUF. The dynamic reduction function DR may be obtained by masking bits βⱼ of occupancy configurations 500:

$$β = {β}_{1} … {β}_{K}$$

made of K bits. The size of the mask may decrease when occupancy configurations are visited a certain number of times. The initial dynamic reduction function DR⁰ may mask all bits for all occupancy configurations such that it is a constant function DR⁰ (B)=0 for all occupancy configurations B. After each coding of an occupancy bit, the dynamic reduction function may evolve from a function DRⁿ to an updated function DRₙ₊₁. The function may be defined by:

$${β}^{′} = D {R}^{n} ( β ) = {β}_{1} … {β}_{kn ( β )}$$

where kₙ(β) 510 is the number of non-masked bits. The initialization of DR⁰ may correspond to k₀(β)=0, and the natural evolution of the reduction function towards finer statistics may lead to an increasing number of non-masked bits kₙ(β)≤kₙ₊₁ (β). The dynamic reduction function may be entirely determined by the values of kₙ for all occupancy configurations β.

The visits to occupancy configurations may be tracked by a variable NV(β′) for all dynamically reduced occupancy configurations β′=DRⁿ(β). After the coding of an occupancy bit based on an occupancy configuration BV, the corresponding number of visits NV(β^{V′}) may be increased by one. If this number of visits NV(β^{V′}) is greater than a threshold th_{V},

$$NV ( {β}^{{V}^{′}} ) > {th}_{V}$$

then the number of unmasked bits kₙ(β) may be increased by one for all occupancy configurations β being dynamically reduced to β^{V′}. Practically, this corresponds to replacing the dynamically reduced occupancy configuration BV′ by the two new dynamically reduced occupancy configurations β^{0′} and β^{1′} defined by

$${β}^{{0}^{′} =} {β}^{{V}^{′}} 0 = {β}_{1}^{V} … {β}_{kn ( β )}^{V} 0 and {β}^{{1}^{′}} = {β}^{{V}^{′}} 1 = {β}_{1}^{V} … {β}_{kn ( β )}^{V} 1.$$

In other words, the number of unmasked bits has been increased by one kₙ₊₁(β)=kₙ(β)+1 for all occupancy configurations β such that DRⁿ(β)=β^{V′}. The number of visits of the two new dynamically reduced occupancy configurations may then be initialized to zero:

$$NV ( {β}^{{0}^{′}} ) = NV ( {β}^{{1}^{′}} ) = 0. \qquad ( I )$$

At the start of the coding, the initial number of visits for the initial dynamic reduction function DR⁰ may be set to

$$NV ( {DR}^{0} ( β ) ) = NV ( 0 ) = 0 ,$$

and the evolution of NV on dynamically reduced occupancy configurations may now be entirely defined.

When a dynamically reduced occupancy configuration β^{V′} is replaced by the two new dynamically reduced occupancy configurations β^{0′} and β^{1′}, the corresponding LUT entry LUT[β^{V′}] may be replaced by the two new entries LUT[β^{0′}] and LUT[β^{1′}] that are initialized by the context index associated with β^{V′},

$$LUT [ {β}^{{0}^{′}} ] = LUT [ {β}^{{1}^{′}} ] = LUT [ {β}^{{V}^{′}} ] , \qquad ( II )$$

and then evolve separately. The evolution of the LUT of context indices on dynamically reduced occupancy configurations may thus be entirely defined.

The reduction function DRⁿ may be modeled by a series of growing binary trees Tⁿ 520 whose leaf nodes 530 are the reduced occupancy configurations β′=DRⁿ(β). The initial tree may be the single root node associated with 0=DR⁰ (β). The replacement of the dynamically reduced to β^{V′} by β^{0′} and β^{1′} corresponds to growing the tree Tⁿ from the leaf node associated with β^{V′} by attaching to it two new nodes associated with β^{0′} and β^{1′}. The tree Tⁿ⁺¹ may be obtained by this growth. The number of visits NV and the LUT of context indices may be defined on the leaf nodes and evolve with the growth of the tree through equations (I) and (II).

In some examples, dynamic OBUF may be practically implemented by storage of the array NV[β′] and the LUT[β′] of context indices, as well as the trees Tⁿ 520. An alternative to the storage of the trees may be to store the array kₙ[β] 510 of the number of non-masked bits.

A limitation for implementing dynamic OBUF may be its memory footprint. In some applications, a few million occupancy configurations may be practically handled, leading to about 20 bits βᵢ constituting an entry configuration β to the reduction function DR. Each bit βᵢ may correspond to the occupancy status of a neighboring cuboid of a current child cuboid or a set of neighboring cuboids of a current child cuboid.

Higher bits βᵢ (e.g. β₀, β₁, etc.) may be the first bits to be unmasked during the evolution of the dynamic reduction function DR. Therefore, the order of neighbor-based information put in the bits βᵢ may impact the compression performance. In some examples, neighboring information may be ordered from highest priority to lower priority and put in this order into the bits βᵢ, from higher to lower weight. For example, the priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge or, worse, only a vertex with the current child node.

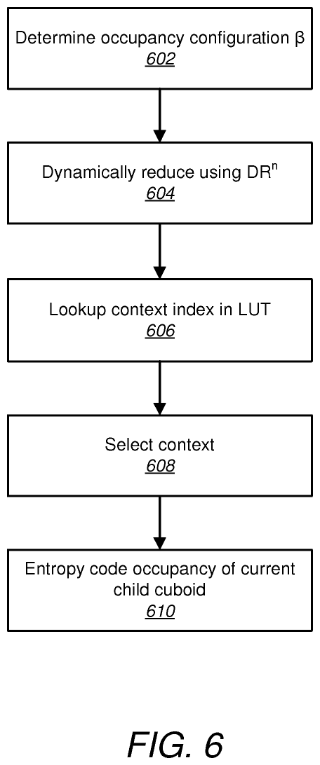

FIG. 6 illustrates a flowchart of an exemplary method for coding the occupancy bit of a current child cuboid using dynamic OBUF. The method of the flowchart begins at block 602. At block 602, an encoder and/or decoder may determine the occupancy configuration B of already-coded cuboids in a neighborhood of the current child cuboid. At block 604, the encoder and/or decoder may dynamically reduce the occupancy configuration β into a reduced occupancy configuration β′=DRⁿ(β). At block 606, the encoder and/or decoder may lookup context index LUT[β′] in the LUT of the dynamic OBUF. At block 608, the encoder and/or decoder may select the context (or probability model) pointed to by the context index. At block 610, the encoder and/or decoder may entropy code (e.g., arithmetic code) the occupancy bit of the current child cuboid based on the context. Thus, the occupancy bit of the current child cuboid may be coded based on occupancy bits of the already-coded cuboids neighboring the current child cuboid.

Although not shown in FIG. 6, the encoder and/or decoder may further update the reduction function DRⁿ into DRⁿ⁺¹ and update the context index LUT[β′] based on the occupancy bit of the current child cuboid. In addition, the method of FIG. 6 may be repeated for additional or all child cuboids of parent cuboids corresponding to nodes of the occupancy tree in a scan order, such as the scan order discussed above with respect to FIG. 3.

In general, the occupancy tree is a lossless compression technique. The occupancy tree may be adapted to provide lossy compression by modifying the point cloud on the encoder side (e.g., down-sampling, removing points, moving points, etc.) but the lossy compression performance may be reduced/weak. However, the use of the occupancy tree as a lossless compression technique may be very useful for dense point clouds.

One approach to lossy compression for point cloud geometry may be to set the maximum depth of the occupancy tree to not reach the smallest volume size of one voxel but instead to stop at a bigger volume size (e.g., N×N×N cubes, where N>1). The geometry of the points belonging to each occupied leaf node associated with the bigger volumes may then be modeled. This approach may be particularly suited for dense and smooth point clouds that may be locally modeled by smooth functions like planes or polynomials. The coding cost may become the cost of the occupancy tree plus the cost of the local model in each of the occupied leaf nodes.

A scheme for modeling the geometry of the points belonging to each occupied leaf node, associated with a volume size larger than one voxel, may use sets of triangles as local models. This scheme may be referred to as the “TriSoup” scheme. TriSoup is short for “Triangle Soup” because the connectivity between triangles may not be part of the models. An occupied leaf node, of an occupancy tree, that corresponds to a cuboid with a volume greater than one voxel may be referred to as a TriSoup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate (a presence of or) whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may further comprise a position (pₖ) of the vertex (Vₖ) along the TriSoup edge.

In addition to the occupancy words of an occupancy tree, an encoder may entropy encode, for each TriSoup node of the occupancy tree, a TriSoup vertex presence flag (and a position of a TriSoup vertex, if present, along a TriSoup edge) of each TriSoup edge belonging to the TriSoup node. A decoder may similarly entropy decode the TriSoup vertex presence flags and positions of each TriSoup vertex along a respective TriSoup edge belonging to a TriSoup node of the occupancy tree, in addition to the occupancy words of the occupancy tree.

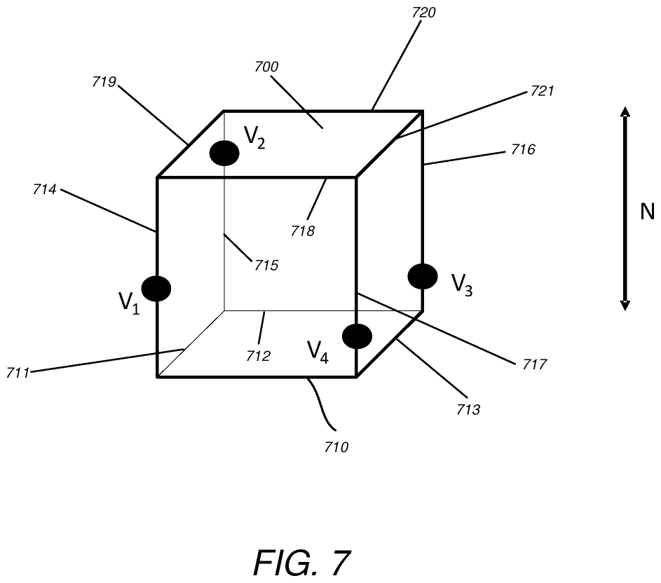

FIG. 7 illustrates an example of an occupied cube 700 of size N×N×N (where N>1) that corresponds to a TriSoup node of an occupancy tree. Occupied cube 700 comprises TriSoup edges 710-721. The TriSoup node, corresponding to occupied cube 700, comprises a presence flag (sₖ) for each TriSoup edge of TriSoup edges 710-721. The presence flag of TriSoup edge 714 indicates that a TriSoup vertex V₁ is present on TriSoup edge 714. The presence flag of TriSoup edge 715 indicates that a TriSoup vertex V₂ is present on TriSoup edge 715. The presence flag of TriSoup edge 716 indicates that a TriSoup vertex V₃ is present on TriSoup edge 716. The presence flag of TriSoup edge 717 indicates that a TriSoup vertex V₄ is present on TriSoup edge 718. The presence flags of the remaining TriSoup edges each indicates that a TriSoup vertex is not present on their corresponding TriSoup edge. The TriSoup node, corresponding to occupied cube 700, further comprises a position (pₖ) for each TriSoup Vertex present along one of its TriSoup edges 710-721. More specifically, the TriSoup node (corresponding to occupied cube 700) further comprises a position p₁ for TriSoup vertex V₁, a position p₂ for TriSoup vertex V₂, a position p₃ for TriSoup vertex V₃, and a position p₄ for TriSoup vertex V₄. The TriSoup vertices may be shared among TriSoup nodes along TriSoup edge(s) in common.

In some examples, a presence flag (sₖ) and, if the presence flag (sₖ) indicates the presence of a vertex, a position (pₖ) (the presence flag (sₖ) and position (pₖ) individually or collectively referred to as vertex information) of the vertex along a current TriSoup edge may be entropy coded based on already-coded presence flags and positions (of present TriSoup vertices) of TriSoup edges that neighbor the current TriSoup edge. A presence flag (sₖ) and, if the presence flag (sₖ) indicates the presence of a vertex, a position (pₖ) on (e.g., indicating a position of the vertex along) a current TriSoup edge may be additionally or alternatively entropy coded based on occupancies of cuboids that neighbor the current TriSoup edge. Similar to the entropy coding of the occupancy bits of the occupancy tree, a configuration βTS for a neighborhood (also referred to as a neighborhood configuration βTS) of a current TriSoup edge may be obtained and dynamically reduced into a reduced configuration βTS′=DRn(βTS) by using a dynamic OBUF scheme for TriSoup. A context index LUT[βTS′] may be obtained from the OBUF LUT and at least a part of the vertex information of the current TriSoup edge may be entropy coded using the context (or probability model) pointed to by the context index.

In order to use a binary entropy coder to entropy code at least part of the vertex information of the current TriSoup edge, the TriSoup vertex position (pₖ) (if present) along its TriSoup edge may be binarized. A number of bits N_{b} may be set for the quantization of the TriSoup vertex position (pₖ) along the TriSoup edge of length N that is uniformly divided into 2^{Nb} quantization intervals. By doing so, the TriSoup vertex position (pₖ) may be represented by N_{b} bits (pₖⱼ, j=1, . . . , Nb) that may be individually coded by the dynamic OBUF scheme as well as the bit corresponding to the presence flag (sₖ). The neighborhood configuration βTS, the OBUF reduction function DRn, and thus the context index may depend on the nature/characteristic/property of the coded bit (presence flag (sₖ), highest position bit (pₖ₁), second highest position bit (pₖ₂), etc.). Therefore, there may be several dynamic OBUF schemes implemented, with each dedicated to a specific bit of information (presence flag (sₖ) or position bit (pₖ₁) of the vertex information.

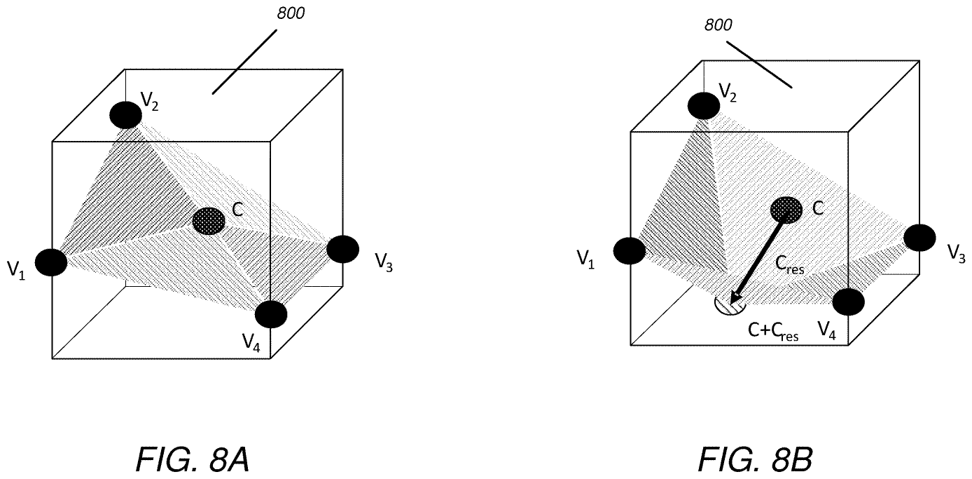

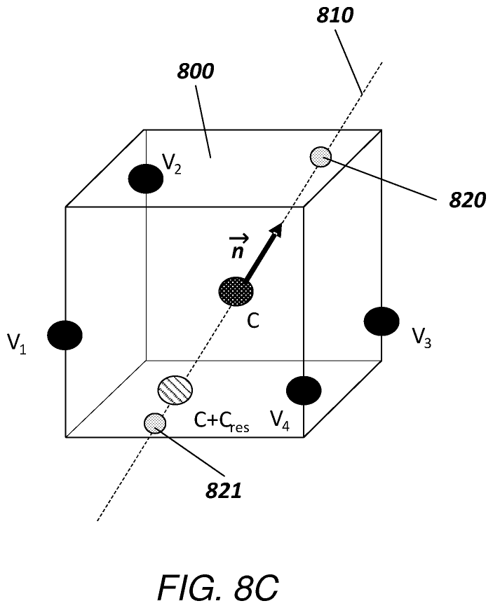

FIG. 8A illustrates a cuboid 800 (e.g., a cube) corresponding to a TriSoup node with a number K of TriSoup vertices Vₖ. Within cuboid 800, TriSoup triangles may be constructed from the TriSoup vertices Vₖ if at least three (K≥3) TriSoup vertices are present on the TriSoup edges of cuboid 800. In the example of FIG. 8A, 4 TriSoup vertices are present and therefore TriSoup triangles are constructed. The TriSoup triangles may be constructed around the centroid vertex C defined as the mean of the TriSoup vertices Vₖ. In some examples, to construct the TriSoup triangles, a dominant direction may first be determined, then vertices Vₖ may be ordered by turning around this direction, and finally the following K TriSoup triangles (listed as triples of vertices) are constructed: V₁V₂C, V₂V₃C, . . . , V_{K}V₁C. The dominant direction may be chosen among the three directions parallel to the axis of the 3D space to increase or maximize the 2D surface of the triangles when projected along the dominant direction. By doing so, the dominant direction may be somewhat perpendicular to a local surface defined by the points of the point cloud belonging to the TriSoup node.

FIG. 8B illustrates a refinement to the TriSoup model by coding a centroid residual vector Cᵣₑₛ into the bitstream such as to use C+Cᵣₑₛ instead of C as a pivoting vertex for constructing/generating the triangles. By doing so, the vertex C+Cᵣₑₛ may be closer to the points of the point cloud than the centroid C used to model the points, which reduces the reconstruction error and leads to lower distortion at the cost of a small increase in bitrate needed for coding Cᵣₑₛ.

FIG. 8C illustrates a more detailed example of coding a centroid residual vector Cᵣₑₛ in/from the bitstream such that an adjusted centroid C+Cᵣₑₛ is used instead of centroid C for generating TriSoup triangles of a cuboid 800 (corresponding to a TriSoup node) corresponding to a portion of a point cloud, according to some embodiments. For example, the triangles may be generated based on adjusted centroid C+Cᵣₑₛ and adjacent pairs of vertices of an ordering of the vertices V₁-V₄, determined as described above with respect to FIG. 8A. Further, as described above, the TriSoup triangles of the cuboid may be voxelized at the decoder to generate voxels representing (or modeling) the portion, of the point cloud, corresponding to the cuboid. A unit vector n (i.e., also referred to as a normalized vector) may be determined as a normalized mean vector of normal vectors to the triangles (V₁V₂C, V₂V₃C, . . . , V_{K}V₁(C) constructed by centroid C and pairs of the vertices of the cuboid by pivoting around the centroid C (e.g., as described in FIG. 8A). For example, the unit vector \vec{n} may be determined as the normalized vector based on a mean of cross-products representing areas of the triangles (\vec{V₁C}×\vec{V₂C}+\vec{V₂C}×\vec{V₃C}+ . . . +\vec{V_{K}C}×)/K. For example, the unit vector \vec{n} may be determined by dividing the mean vector (n) by the norm (or length) of the mean vector (i.e., \vec{n}=n/∥n∥).

A value resulting from each cross product is equal to an area of a parallelogram formed by the two vectors in the cross product. Therefore, the value may be representative of an area of a triangle formed by the two vectors because the area of the triangle is equal to half of the value. Accordingly, since the vector \vec{n} indicates a direction of the triangles (e.g., TriSoup triangles) representing (e.g., modeling) the portion of the point cloud, the vector \vec{n} may be indicative of the direction normal to a local surface representative of the portion of the point cloud. In some examples, to maximize the effect of the centroid residual while minimizing its coding cost, a one-component residual αᵣₑₛ along the line (C, \vec{n}) 810 may be coded instead of a 3D residual vector.

$${C}_{res} = {α}_{res} \vec{n}$$

The residual value αᵣₑₛ may be determined by the encoder as the intersection between the current point cloud and the line (C, \vec{n}), which is along the same direction of the normalized vector \vec{n}. For example, a set of points, of the portion of the point cloud, closest (e.g., within a threshold distance, a threshold number of points) to the line may be determined. The set of points may be projected on the line and the residual value αᵣₑₛ may be determined as the mean component along the line of the projected points. In some examples, the mean may be determined as a weighted mean whose weights depend on the distance of the set of points from the line. For example, a point from the set closer to the line may have a higher weight than another point from the set farther from the line.

In some examples, the residual value αᵣₑₛ may be quantized. For example, it may be quantized by a uniform quantization function having quantization step similar to the quantization precision of the TriSoup vertices Vₖ. By doing so, the quantization error may be maintained to be uniform over all vertices Vₖ and C+Cᵣₑₛ such that the local surface is uniformly approximated.

In some examples, the residual value αᵣₑₛ may be binarized and entropy coded into the bitstream, e.g., by using a unary-based coding scheme. In some examples, the residual value αᵣₑₛ may be coded using a set of flags. For example, a flag f₀ may be coded to indicate if the residual value αᵣₑₛ is equal to zero. If the flag f₀ indicates the residual value αᵣₑₛ is zero, no further syntax elements may be needed. If the flag f₀ indicates the residual value αᵣₑₛ is not zero, a sign bit indicating a sign may be coded and the residual magnitude |αᵣₑₛ|−1 may be coded using an entropy code. For example, the residual magnitude may be coded using a unary coding scheme that codes successive flags fᵢ (i≥1) indicating if the residual value magnitude |αᵣₑₛ| is equal to ‘i’. A binary entropy coder may binarize the residual value αᵣₑₛ into the flags fᵢ (i≥0) and entropy code the binarized residual value as well as the sign bit.

In some examples, compression of the residual value αᵣₑₛ may be improved by determining bounds as shown in FIG. 8C. As shown, the line (C, \vec{n}) 810 intersects the current cuboid 800 (corresponding to a TriSoup node) at two bounding points 820 and 821 and the encoder may impose that the adjusted centroid vertex C+Cᵣₑₛ is located between the two bounding points 820 and 821. These bounding points 820 and 821 also bounds the residual value αᵣₑₛ (which may be quantized) as belonging to an integral interval [m, M] where m≤0≤M. By doing so, some bits of the binarized residual value αᵣₑₛ may be inferred. For example, if m=M=0, then residual value αᵣₑₛ is necessarily equal to zero. In another example, if m=0<M, then the sign bit is necessarily positive. More generally, if the residual value αᵣₑₛ is not equal to zero and its sign is known, its magnitude |αᵣₑₛ| may be determined to be bounded by either |m| or M such that the magnitude may be coded by a truncated unary coding scheme that may infer the value of the last of successive flags fᵢ (i≥1).

In some examples, the binary entropy coder used to code the binarized residual value αᵣₑₛ may be a context-adaptive binary arithmetic coder (CABAC) such that the probability model (also referred to as a context or an entropy coder) used to code at least one bit (e.g., fᵢ or sign bit) of the binarized residual value αᵣₑₛ are updated depending on precedingly coded bits. In some examples, the probability model of the binary entropy coder may be determined based on contextual information such as the values of the bounds m and M, the position of vertices Vₖ, or the size of the cuboid. In some examples, the selection of the probability model (i.e., also referred equivalently as an entropy coder or context) may be performed by a dynamic OBUF scheme with the contextual information described above as inputs.

The reconstruction of a decoded point cloud from the set of TriSoup triangles may be referred to as “voxelization” and may be performed, e.g., by ray tracing or rasterization, for each triangle individually before duplicate voxels from the voxelized triangles are removed.

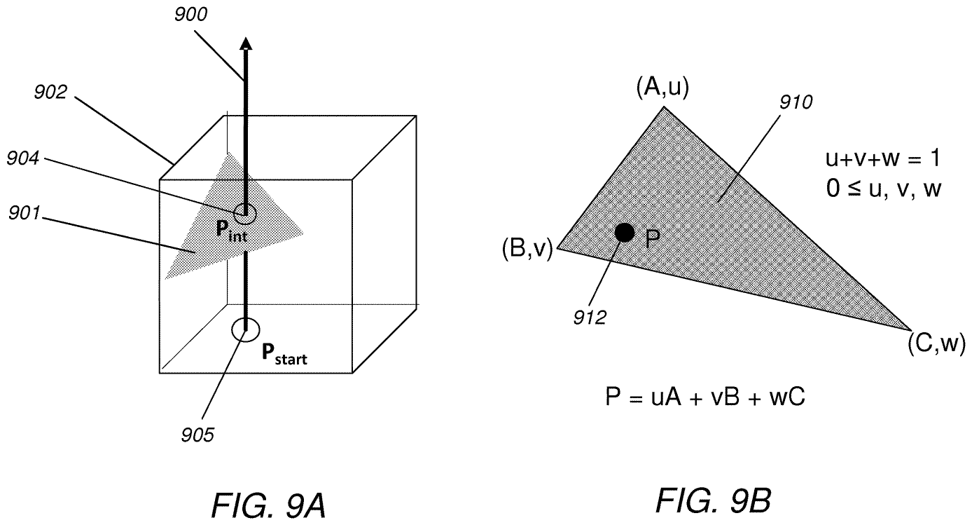

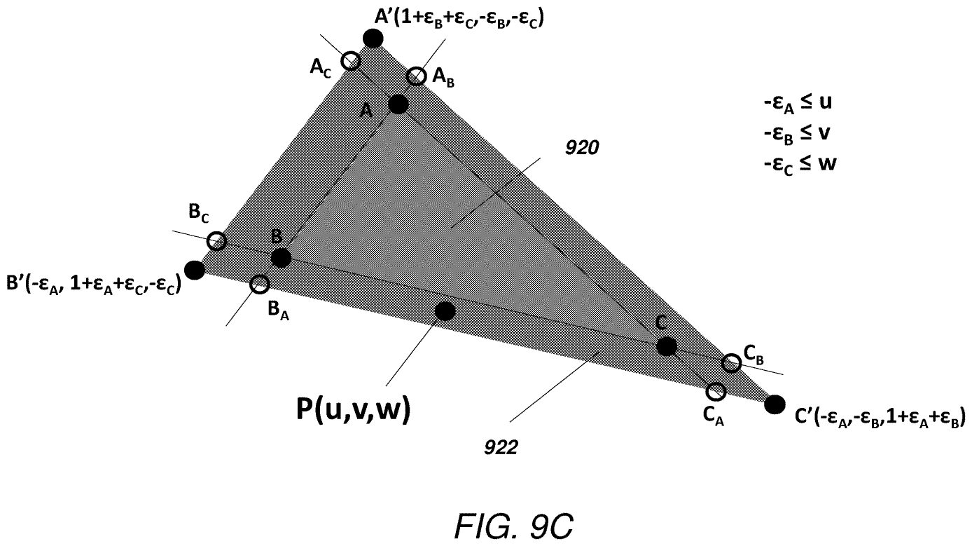

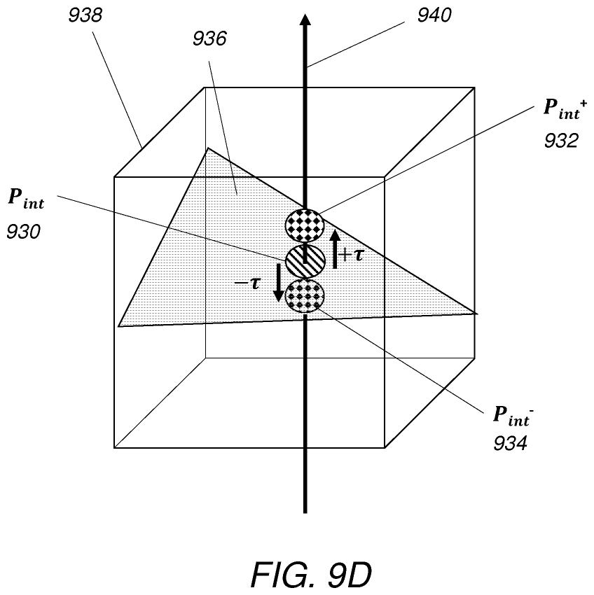

FIG. 9A illustrates an example of voxelization using ray tracing, according to some embodiments. For example, ray-triangle intersection algorithms, such as the Möller-Trumbore algorithm, rely on launching rays to determine whether rays intersect with TriSoup triangles and if so, at what points of the TriSoup triangles. Rays may be launched from integral coordinates that correspond to the centers of voxels. As illustrated by FIG. 9A, rays such as ray 900 may be launched parallel to one of the three coordinate axes of the 3D space, starting from integral coordinates (sometimes referred to as integer coordinates) such as an origin point 905 (shown as origin or starting point Pₛₜₐᵣₜ).

An intersection point 904 (shown as Pᵢₙₜ), if any, between ray 900 and a TriSoup triangle 901 belonging to a cube 902, corresponding to a TriSoup node, may be rounded (or quantized) to obtain a decoded point corresponding to a voxel. For example, a ray, launched parallel to a coordinate axis in 3D space, may intersect a TriSoup triangle if and only if the projection, along the ray direction, of the center of a voxel belongs to the TriSoup triangle. In other words, the ray may be determined to intersect the TriSoup triangle if the point of intersection corresponds to the center of the voxel. In some examples, this intersection may be determined by applying a ray-triangle intersection algorithm (e.g., tracing or ray casting technique) such as the Möller-Trumbore algorithm to generate voxels representing the triangle.

Ray tracing techniques such as the Möller-Trumbore algorithm is based on generating, with respect to a triangle, barycentric coordinates of points of intersection between rays and a plane of the triangle. Then, points of the triangle may be determined from the barycentric coordinates.

FIG. 9B illustrates an example of voxelization using barycentric coordinates (u, v, w) of a point 912 (P) relative to a TriSoup triangle 910 having vertices labeled A, B, and C in the 3D space, according to some embodiments. In some examples, point 912 may be determined as an intersection between a ray and a plane of TriSoup triangle 910 (e.g., containing or passing through the three vertices A, B, and C of TriSoup triangle 910). For example, the ray may be launched parallel to one of the three coordinate axes in 3D space. In some examples, this intersection point 912 may be uniquely represented as a sum of the three vertices of TriSoup triangle 910:

$$P = uA + vB + wC$$

under the condition u+v+w=1. Therefore, any point P of the plane (containing TriSoup triangle 910) has unique coordinates (u,v,w) in the barycentric coordinate system. A point with barycentric coordinates (u,v,w) includes an ordered triple of numbers u, v, and w. A point with barycentric coordinates (u,v,w) that sum to 1 (i.e., u+v+W=1) is known as homogeneous barycentric coordinates or normalized barycentric coordinates. The barycentric coordinates of the intersection point with respect to TriSoup triangle 910 may be determined using, e.g., the well-known Möller-Trumbore algorithm.

By converting points with Cartesian coordinates in 3D space to homogeneous barycentric coordinates, the three vertices A, B, C of TriSoup triangle 910 have respective barycentric coordinates A(1,0,0), B(0,1,0) and C(0,0,1). In some examples, the convex hull (i.e., TriSoup triangle 910) of the three vertices A, B, and C is equal to the set of all points such that the barycentric coordinates u, v, and w is each greater than or equal to zero:

$$0 \leq u , y , w$$

Therefore, in some examples, the intersection point may be determined to belong to TriSoup triangle 910 based on the intersection point having barycentric coordinates with an ordered triple of values that is each greater than or equal to zero. Relatedly, if at least one of barycentric coordinates (i.e., one of u, v, or w) is negative or less than 0, then the intersection point may be determined to not belong to TriSoup triangle because it will be on the plane, but not on an edge or within the TriSoup triangle. In some examples, a point determined to belong to TriSoup triangle 910 may be the ray intersecting TriSoup triangle 910 (e.g., within or at an edge of TriSoup triangle 910).

FIG. 9C illustrates an example of the halo technique in which one or more inequalities of barycentric coordinates u, v, and w are relaxed to generate a halo 922 extending from one or more edges of triangle 920 (e.g., a TriSoup triangle), according to some embodiments. In particular, the three inequalities 0≤u, v, w of barycentric coordinates u, v, and w (as described in FIG. 9B) may be relaxed into less constraining hull inequalities −ε_{A}≤u, −ε_{B}≤v and ε_{C}≥w by applying three halo parameters ε_{A}, ε_{B} and ε_{C} (which may be positive values or zero with at least one parameter being positive). In other examples, the less constraining inequalities may be represented as ε_{A}≤u, ε_{B}≤v and ε_{C}≤w where the three halo parameters ε_{A}, ε_{B} and ε_{C} are negative values or zero with at least one parameter being negative. Applying these one or more halo parameters to the barycentric coordinates of a point with respect to triangle 920 is represented graphically by a halo 922 that is added to triangle 920 all around the three edges AB, BC, and AC of triangle 920. Halo 922 extends the original triangle 920 to correspond to a new triangle A′B′C′ whose one or more vertices are derived from extending one or more vertices of original triangle 920 outwards with respect to triangle 922. For example, by applying the one or more three parameters, the three halo vertices A′, B′ and C′ may have barycentric coordinates determined as A′(1+ε_{B}+ε_{C},−ε_{B},−ε_{C}), B′(−ε_{A}, 1+ε_{A}+ε_{C},−ε_{C}), and C′(−ε_{A}, −ε_{B}, 1+ε_{A}+ε_{B}), respectively. In some examples, the three halo parameters ε_{A}, ε_{B}, and ε_{C} may be all equal to a same halo parameter ε such that the halo is defined by the follow inequalities on barycentric coordinates −ε≤u, v, w. In other examples, each of the three halo parameters ε_{A}, ε_{B}, and ε_{C} may be set separately and may have different parameter values.

In the Möller-Trumbore algorithm, an intersection point of a ray with the plane to which a TriSoup triangle belongs is determined based on computing, for the intersection point, the barycentric coordinates values of u, v, and w. Then, the intersection point may be determined to be in the TriSoup triangle (e.g., on an edge of or within the TriSoup triangle) based on verifying that each of the barycentric coordinates u, v, and w is greater or equal to 0 (e.g., 0≤u, v, w). Otherwise, the intersection point is determined as being outside of the TriSoup triangle. As described above, the halo technique may replace one or more of the inequalities in the verification based on one or more parameter −ε_{A}≤u, −ε_{B}≤v and −ε_{C}<w such that the intersection point is confirmed to be in (or belonging to) the TriSoup triangle extended by its halo. Accordingly, the halo technique does not increase complexity or significantly increase processing needs.

FIG. 9D illustrates an example of enhancing voxelization of a TriSoup triangle 936 based on adding one or more points based on a point determined to be in TriSoup triangle 936 (i.e., also referred to as applying the “thickness” of TriSoup triangles technique), according to some embodiments. For example, the point may be an intersection point between ray 940 and TriSoup triangle 936. For example, FIG. 9D shows a TriSoup triangle 936, belonging to a cuboid 938 corresponding to a TriSoup node and one or more points 932 and 934 being determined based on a point 930 in (e.g., within or on an edge of) TriSoup triangle 936. As used herein, a point determined to be in a TriSoup triangle may refer to the point being inside of or on an edge of that TriSoup triangle. In some examples, one or more of points 932 and 934 are determined from point 930 and are not on the same plane as TriSoup triangle 936 containing point 930.

In some examples, point 930 may be an intersection point Pᵢₙₜ determined between a ray 940 and TriSoup triangle 936. For example, ray 940 may be launched from integral coordinates and in a direction that may be parallel to a coordinate axis (e.g., x-axis, y-axis, or z-axis) in 3D space. In some examples, rays may be launched along one or more coordinate axes in 3D space. For example, rays may be launched from one or more of the coordinate axes in order of coordinate axes determined to be most perpendicular to a plane of TriSoup triangle 936. In an example, rays may be launched from at most two of the three coordinate axes determined to be most perpendicular to (or most parallel to a normal of) TriSoup triangle 936.

As described above, this intersection may be determined based on computing barycentric coordinates such as in the Möller-Trumbore algorithm. In some examples, point 930 may be voxelized (e.g., rounded or quantized to a closest voxel along ray 940) and added to a list of decoded points (or voxels) of a decoded point cloud. In some examples, the one or more points 932 and 934 may be determined from point 930 based on adding and/or subtracting a vector with a magnitude equal to a value (also referred to as a thickness value τ). For example, point 934

$$( {P}_{int}^{-} )$$

and point 932

$$( {P}_{int}^{+} )$$

may be determined by subtracting and adding the vector with magnitude equal to t as follows:

$${P}_{int}^{\pm } = {P}_{int} \pm \vec{{n}_{ray}}$$

where \vec{n_{ray}} is vector with a magnitude of t. For example, point 932

$$( {P}_{int}^{+} )$$

may be indicated by point 930 displaced by the value (or distance) of τ in a first direction of vector \vec{n_{ray}} and point 934

$$( {P}_{int}^{-} )$$

may be indicated by point 930 displaced by the the value (or distance) of τ in a second direction opposite the first direction. In some examples, the vector Pray may be parallel to ray 940, which may be launched parallel to a coordinate axis. In addition to point 930, the two extra points 932 and 934

$$( i . e . , points {P}_{int}^{-} and {P}_{int}^{+} )$$

may also be voxelized (e.g., quantized or rounded) and added to the list of decoded points (or corresponding voxels) of the decoded point cloud. Often, the voxelization of the three points 930, 932, and 934

$$( i . e . , {P}_{int} , {P}_{int}^{-} and {P}_{int}^{+} )$$

may result in the same same voxelized decoded point (or voxel). In some examples, based on the τ value being smaller than, e.g., ¼, the three points 930, 932, and 934 may be voxelized to at most two voxels.

In some examples, point 934

$$( {P}_{int}^{-} )$$

and point 932

$$( {P}_{int}^{+} )$$

may be determined by subtracting and adding the vector, with magnitude equal to t, that is perpendicular to TriSoup triangle 936 as follows:

$${P}_{int}^{\pm } = {P}_{int} \pm \vec{{n}_{tri}}$$

where \vec{nₜᵣᵢ} is a vector perpendicular to TriSoup triangle 936 and having a magnitude of τ. In some examples, point 930 (e.g., point Pᵢₙₜ) may be determined by a voxelization method different from ray tracing such as a rasterization technique in which TriSoup triangle 936 may be converted to a triangle in 2D from which points of the triangle are determined and projected back to 3D. For example, well-known voxelization techniques based on the digital differential analyzer (DDA) algorithm or the Bresenham algorithm may be used.

In some examples, the value τ may be a predetermined value such as, e.g., ⅛ of a size of voxel. For example, the value τ may be defined relative to a size of voxel. In some examples, the value τ may be a parameter (e.g., “thickness” parameter) determined by an encoder and signaled as an indication to a decoder.

In some examples, one or two of these extended points may be determined for each point (e.g., intersection point) determined in TriSoup triangle 936. For example, it can imagined that by determining a plurality of points in TriSoup triangle 936 above and below points of TriSoup triangle 936 by a distance/value of τ, TriSoup triangle 936 may be extended by two parallel planes of points and is equivalent to replacing TriSoup triangle 936 by a prism of height 2τ. In an example, the prism may be an oblique prism when the two additional points

$${P}_{int}^{-} and {P}_{int}^{+}$$

are obtained based on the vector \vec{n_{ray}}, which is parallel to the rays. In an example, the prism may be a right prism when the two extra points

$${P}_{int}^{-} and {P}_{int}^{+}$$

are obtained based on the vector \vec{nₜᵣᵢ} perpendicular to TriSoup triangle 936. Therefore, the height or the prism may be seen as a “thickness” of TriSoup triangle 936 and the value τ may therefore also be referred to as a thickness parameter or a thickness value. In some examples, when the value τ is small, voxelization of the intersection of the ray with the prism may be equivalent to the proposed method based on the voxelization of the three points Pᵢₙₜ,

$${P}_{int}^{-} and {P}_{int}^{+} .$$

In some examples, the parameter for value τ and/or the base halo parameters ε may be predetermined (e.g., fixed in the specification of the codec). In other examples, the parameter for value τ and/or the base halo parameters ε may depend on the properties of the original point cloud, and therefore may be determined by the encoder and sent to the decoder. Therefore, the parameter for value τ and/or the base halo parameters ε may be encoded into the bitstream and decoded by the decoder.

In some examples, the parameter for value τ and/or the base halo parameters ε may be encoded into the bitstream at a sequence level (e.g., into Sequence Parameter Set or SPS), at a frame level (e.g., into a Geometry Parameter Set or GPS) or at a more local level. For example, the parameter for value τ and/or the base halo parameters ε may be encoded per slice/brick into a Geometry Brick Header or GBH.

In some examples, the encoder may signal an activation flag indicating whether proposed mechanism based on the value τ is to be performed by the decoder in voxelizing TriSoup triangles. For example, the activation flag may be encoded into either a Sequence Parameter Set (SPS), a Geometry Parameter Set (GPS) or a Geometry Brick Header (GBH). The decoder may receive and decode the activation flag from the bitstream.

Presence flags (sₖ) and positions (pₖ) of TriSoup vertices on TriSoup edges can be efficiently entropy coded using neighboring information of neighboring, already-coded TriSoup edges (e.g., already-coded flags and positions of TriSoup vertices) and the occupancy of cuboids neighboring the TriSoup edges. Specifically, a presence flag (sₖ) and, if the presence flag (sₖ) indicates the presence of a vertex, a position (pₖ) of the vertex along a current TriSoup edge may be entropy coded based on already-coded presence flags and positions (of present TriSoup vertices) of TriSoup edges that neighbor the current TriSoup edge. A presence flag (sₖ) and, if the presence flag (sₖ) indicates the presence of a vertex, a position (pₖ) on (e.g., indicating a position of the vertex along) a current TriSoup edge may be additionally or alternatively entropy coded based on occupancies of cuboids that neighbor the current TriSoup edge. The presence flag (sₖ) and position (pₖ) may be individually or collectively referred to as vertex information. Similar to the entropy coding of the occupancy bits of the occupancy tree, a configuration βTS for a neighborhood (also referred to as a neighborhood configuration βTS) of a current TriSoup edge may be obtained and dynamically reduced into a reduced configuration βTS′=DRn(βTS) by using a dynamic OBUF scheme for TriSoup. A context index LUT[βTS′] may be obtained from the OBUF LUT and at least a part of the vertex information of the current TriSoup edge may be entropy coded using the context (also referred to as probability model or entropy coder) pointed to by the context index.

In order to use a binary entropy coder to entropy code at least part of the vertex information of the current TriSoup edge, the TriSoup vertex position (pₖ) (if present) along its TriSoup edge may be binarized. A number of bits N_{b} may be set for the quantization of the TriSoup vertex position (pₖ) along the TriSoup edge of length N that is uniformly divided into 2^{Nb} quantization intervals. By doing so, the TriSoup vertex position (pₖ) may be represented by N_{b} bits (pₖ^{j}, j=1, . . . , N_{b}) that may be individually coded by the dynamic OBUF scheme as well as the bit corresponding to the presence flag (sₖ). The neighborhood configuration β_{TS}, the OBUF reduction function DRⁿ, and thus the context index may depend on the nature/characteristic/property of the coded bit (presence flag (sₖ), highest position bit (pₖ₁), second highest position bit (pₖ²), etc.). Therefore, there may be several dynamic OBUF schemes implemented, with each dedicated to a specific bit of information (presence flag (sₖ) or position bit (pₖ^{j})) of the vertex information.

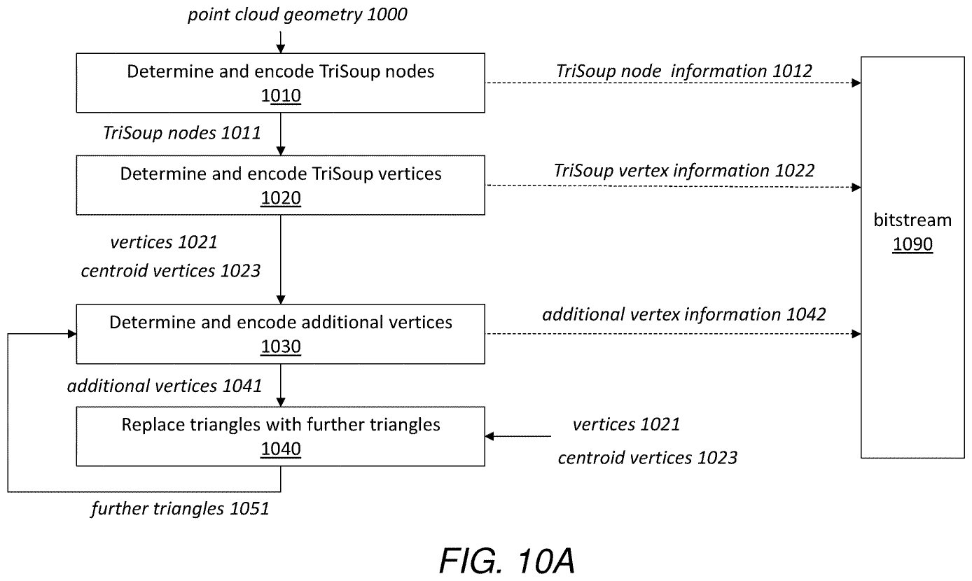

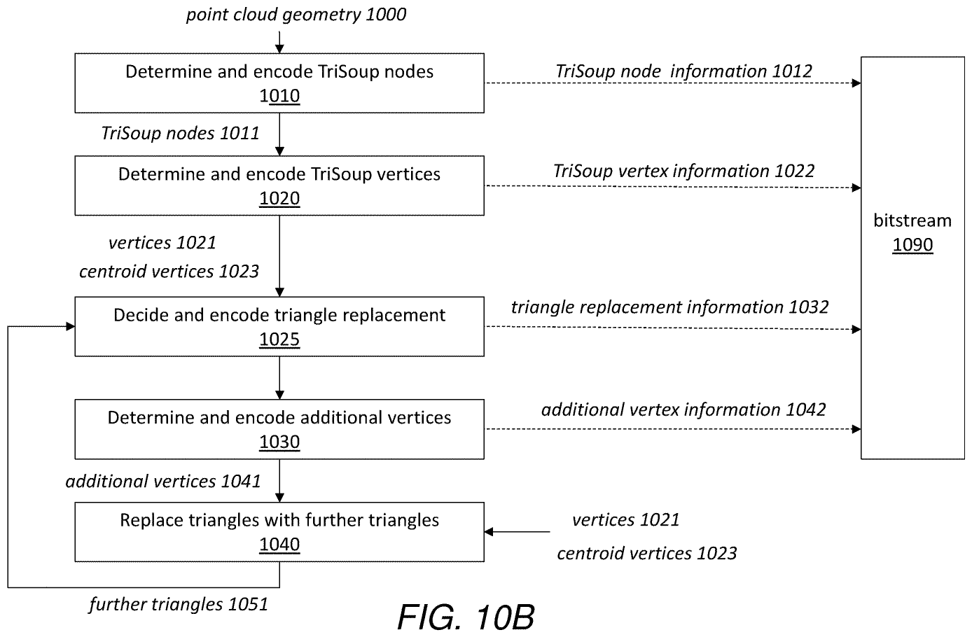

FIG. 10A illustrates an example process for encoding in a bitstream 1090 a point cloud geometry 1000 using a TriSoup geometry scheme, according to some embodiments. For example, the process of FIG. 10A may be performed by an encoder (e.g., encoder 114 of FIG. 1). In some examples, blocks 1010, 1020, 1030 and 1040 may represent components within the encoder.

At block 1010, TriSoup nodes 1011 are determined by using an occupancy tree (e.g., an octree). For example, occupied leaf nodes of the octree may correspond to (e.g., defined as) the TriSoup nodes, and TriSoup node information 1012 related to the determination of the TriSoup nodes is encoded in the bitstream 1090. For example, the TriSoup node information 1012 may indicate the occupancy information of the occupancy tree (e.g., octree).

At block 1020, TriSoup vertices 1021 (Vₖ) located on edges (e.g., TriSoup edges) of volumes (e.g., cuboids) associated with TriSoup nodes 1011 are determined. TriSoup vertex information 1022 indicating the positions of the TriSoup vertices 1021 on TriSoup edges is encoded in the bitstream 1090.

In some embodiments, the TriSoup vertex information 1022 may indicate the presence of a TriSoup vertex 1021 on a TriSoup edge. Based on the TriSoup vertex information 1022 indicating the presence of a TriSoup vertex on a TriSoup edge, the TriSoup vertex may further comprise information to indicate the position of the TriSoup vertex along the TriSoup edge.

In some embodiments, the TriSoup vertex information 1022 comprises a flag (e.g., a binary value or a syntax element) indicating the presence of a TriSoup vertex on a TriSoup edge.

The TriSoup triangles are added to a set of triangles representing a geometry of the point cloud. At least one triangle, of the set of triangles, representing a portion of the point cloud geometry may then be iteratively replaced with further triangles according to the following blocks 1030-1040. For example, to replace the triangle, the triangle is removed from the set of triangles and the further triangles are added to the set of triangles. At each iteration, the at least one triangle is replaced in the set of triangles with further triangles. The number of iterations may be set (e.g., 1), signaled in bitstream 1090, or be based on a criterion, as further described below.

In some embodiments, the at least one triangle comprises all the triangles of the set of triangles.

In some embodiments, the at least one triangle comprises some of the triangles of the set of triangles.

In some embodiments, the set of triangle comprises subsets of triangles to be replaced by further triangles. In an example, a subset of triangles may be a single triangle (e.g., a TriSoup triangle or a derived triangle). In an example, a subset of triangles may be a pair of adjacent triangles (e.g., including TriSoup triangle(s) and/or derived triangle(s). For ease of explanation, in blocks 1030-1040, the at least one triangle refers to a subset of triangles that are replaced. It should be understood that the set of triangles, representing the point cloud geometry, may comprise a plurality of subsets of triangles, each subset of triangles being replaced by further triangles associated with that subset of triangles.

At block 1030, an additional vertex 1041 (V_{add}) is derived from vertices 1021 of the at least one triangle being replaced and an additional vertex information 1042 indicating the position of the additional vertex 1041 is encoded in the bitstream 1090.

At block 1040, the at least one triangle in the set of triangles is replaced with further triangles 1051 derived from the vertices of the at least one triangle and the additional vertex 1041.

In some embodiments, the further triangles 1051 may be further derived from centroid vertices 1023 based on vertices of the at least one triangle.

In some embodiments, the further triangles 1051 may be further derived based on pairs of the vertices of the at least one triangle and pivoting around the additional vertex associated 1041.

In some embodiments, the pairs of the vertices of the at least one triangle may comprise the centroid vertices 1023.

After a first iteration of blocks 1030-1040, the set of triangles may comprise TriSoup triangles and triangles obtained by replacing TriSoup triangles or pairs of adjacent TriSoup triangles (e.g., two TriSoup vertices sharing a common edge) as detailed below. After at least one iteration, the set of triangles may also comprise triangles obtained by iteratively replacing triangles (e.g., TriSoup or non-TriSoup triangles) of the set of triangles.

FIG. 10B illustrates an example process for encoding a point cloud geometry using a TriSoup geometry scheme, according to some embodiments. For example, the process of FIG. 10B may be performed by an encoder (e.g., encoder 114 of FIG. 1). In some examples, block 1025 may represent a component within the encoder.

The process of FIG. 10B may include the same operations (shown as having the same labeled blocks) as those described in FIG. 10A. Different from the process of FIG. 10A, the process of FIG. 10B includes block 1025. At block 1025, it is determined whether the at least one triangle of the set of triangles is replaced (or not) with further triangles. Including the replacement determination provides flexibility to the encoder because triangles in regions of interest can be replaced with further triangles to improve quality of an approximation of a portion of the point cloud geometry and triangles in other regions can remain unchanged (e.g., not replaced by further triangles) to reduce bandwidth.

In some embodiments, the replacement determination is based on criterion evaluated based on the portion of the point cloud geometry and the at least one triangle representing a portion of the point cloud geometry. For example, the at least one triangle may be a single triangle in a TriSoup node or a pair of adjacent triangles in one or two TriSoup nodes. Accordingly, the criterion may be evaluated locally as it is limited to one or two TriSoup nodes and thus need not apply to the entire point cloud geometry.

In some embodiments, the quality of approximation of the portion of the point cloud by the further triangles is based on a rate distortion optimization cost evaluated to encode the further triangles.

The encoder may test the replacement of each triangle or pair of adjacent triangles, may compute an associated decrease ΔD<0 of distortion, due to a better approximation by smaller triangles, and increase ΔR>0 of bitrate, due to extra signaling of the additional vertex position. A cost difference ΔC=ΔD+λ ΔR is then computed for some fixed so-called Lagrange parameter λ, and the replacement decision may depend on the sign of the cost difference ΔC; a replacement may be applied in case ΔC<0.

In a variant, still at block 1025, triangle replacement information 1032, indicating the at least one triangle is replaced, may be encoded in the bitstream 1090.

According to the variant illustrated in FIG. 10B, after a first iteration of blocks 1025-1040, the set of triangles may comprise TriSoup triangles and triangles obtained by replacing TriSoup triangles or a pairs of adjacent TriSoup triangles (two TriSoup vertices sharing a common edge) as detailed below. After several iterations, the set of triangles may also comprise triangles obtained by iteratively replacing triangles (TriSoup or no-TriSoup) triangles of the set of triangles.

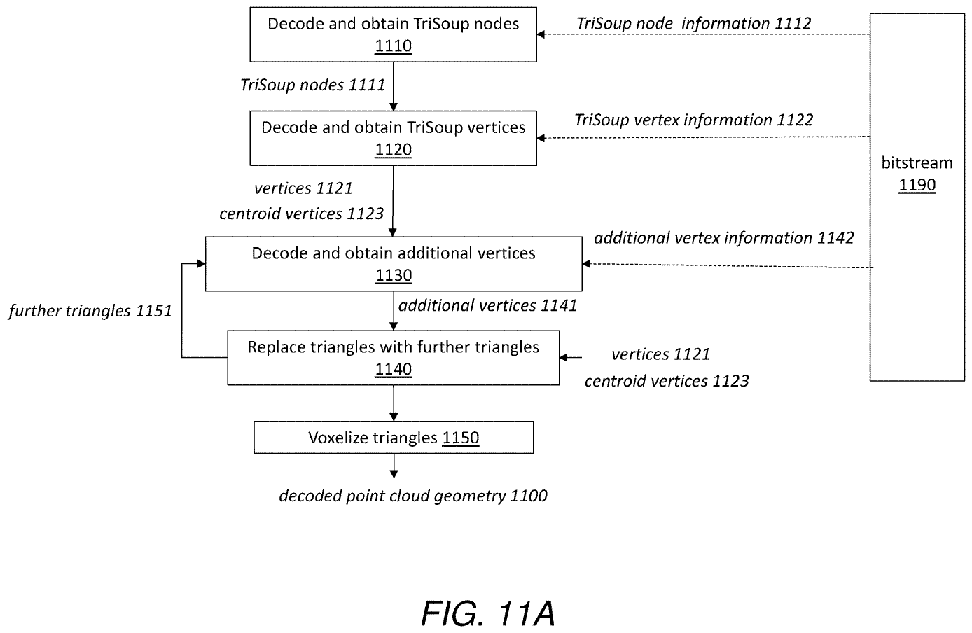

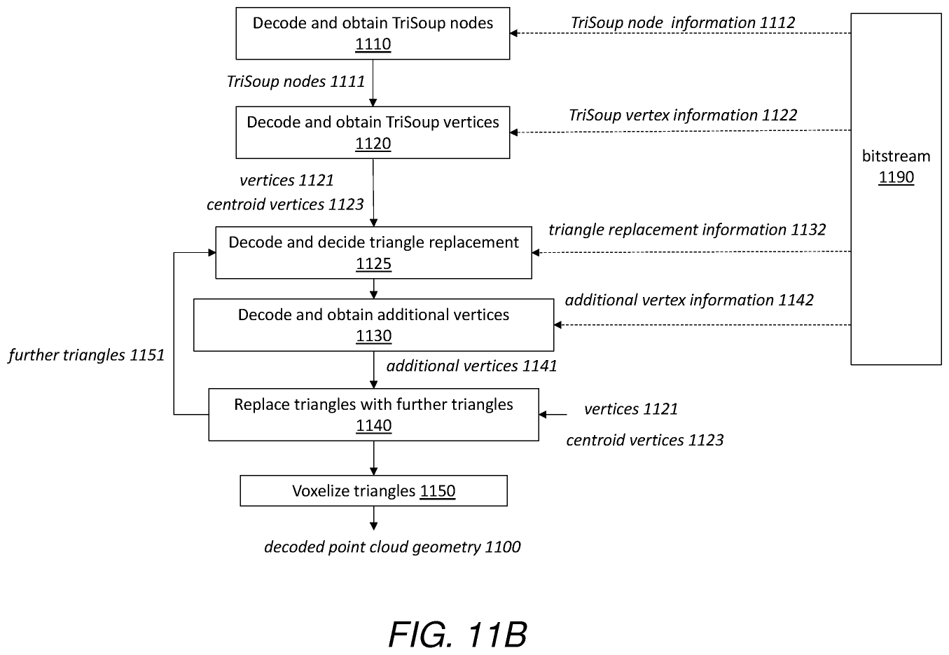

FIG. 11A illustrates an example process for decoding a point cloud geometry using a TriSoup geometry scheme, according to some embodiments. The process decodes, from a bitstream 1190, information representative of a point cloud geometry encoded by the process of FIG. 10A or FIG. 10B and obtains a decoded point cloud geometry 1100. For example, the process of FIG. 11A may be performed by a decoder (e.g., decoder 120 of FIG. 1). In some examples, blocks 1110, 1120, 1130, 1140, and 1150 may represent components within the decoder.

At block 1110, TriSoup nodes 1111 are obtained by decoding, from the bitstream 1190, TriSoup node information 1112 from the bitstream 1190.

For example, the TriSoup node information 1112 may be made of the occupancy information of an occupancy tree, for example an octree, whose occupied leaf nodes are defined as TriSoup nodes.

At block 1120, TriSoup vertices 1121 located on TriSoup edges are obtained by decoding, from the bitstream 1190, TriSoup vertex information 1122 indicating positions of the TriSoup vertices 1121 on TriSoup edges.

In some embodiments, the TriSoup vertex information 1122 may indicate the presence of a TriSoup vertex 1121 in a TriSoup edge; and when the TriSoup vertex information 1122 indicates the presence of a TriSoup vertex on a TriSoup edge, the TriSoup vertex information 1122 may further comprise information to indicate the position of the TriSoup vertex along the TriSoup edge.

In some embodiments, the TriSoup vertex information 1122 comprises a flag (e.g., a binary value or a syntax element) indicating the presence of a TriSoup vertex on a TriSoup edge.

The TriSoup vertices and TriSoup edges define TriSoup triangles that are added to a set of triangles.

At least one triangle of the set of triangles representing a portion of a point cloud geometry is iteratively replaced with further triangles in the set of triangles according to the following blocks 1130-1140. At each iteration, the at least one triangle is replaced in the set of triangles with further triangles.

In some embodiments, the at least one triangle comprises all the triangles of the set of triangles.

In some embodiments, the at least one triangle comprises some of the triangles of the set of triangles.

At block 1130, an additional vertex information 1142 is decoded from the bitstream 1190. The additional vertex information 1142 indicates a position of an additional vertex 1141 derived from vertices 1121 of the at least one triangle being replaced.

At block 1140, the at least one triangle is replaced in the set of triangles with further triangles 1151. The further triangles 1151 are derived from the additional vertex 1141 together with the vertices 1121 of the at least one triangle being replaced.

In some embodiments, the further triangles 1151 may be further derived from centroid vertices 1123 based on vertices of the at least one triangle.

In some embodiments, the further triangles 1151 may be further derived based on pairs of the vertices of the at least one triangle and pivoting around the additional vertex 1141.

In some embodiments, the pairs of the vertices of the at least one triangle may comprise the centroid vertices 1123.

Once the iterations of performing blocks 1130-1140 has completed, at block 1150, triangles of the set of triangles may be voxelized to obtain a set of points that constitute the decoded point cloud geometry 1100.

FIG. 11B illustrates another example process for decoding a point cloud geometry using a TriSoup geometry scheme, according to some embodiments. For example, the process of FIG. 11B may be performed by a decoder (e.g., decoder 120 of FIG. 1). In some examples, block 1125 may represent a component within the decoder.

The process of FIG. 11B may include the same operations (shown as having the same labeled blocks) as those described in FIG. 11A. Different from the process of FIG. 11A, the process of FIG. 11B includes block 1125. At block 1125, triangle replacement information 1132 indicating the at least one triangle is replaced is decoded from the bitstream 1190. The additional vertex information is decoded based on the triangle replacement information 1132.

This variant provides flexibility to the decoder, according to the encoding decisions of the encoder, because triangles in regions of interest can be replaced with further triangles to improve quality of an approximation of a portion of the point cloud geometry and triangles in other regions can remain unchanged (not replaced by further triangles) to reduce bandwidth.

According to the variant illustrated in FIG. 11B, after a first iteration of blocks 1125-1140, the set of triangles may comprise non-replaced TriSoup triangles and triangles obtained by replacing TriSoup triangles. The set of triangles may also comprise triangles obtained by iteratively replacing TriSoup triangles and/or triangles replacing TriSoup triangles.

In some embodiments of a process of FIG. 10A, 10B, 11A, or 10B, the triangle replacement information indicates the at least one triangle comprises one triangle.

In some embodiments, triangles are replaced independently of one or more other triangles being replaced.

In some embodiments of a process of FIG. 10A, 10B, 11A, or 10B, the triangle replacement information indicates the at least one triangle comprises a pair of adjacent triangles.

In some embodiments, the pair of adjacent triangles are triangles that share a common edge.

In some embodiments, the at least one triangle comprises pairs of adjacent triangles that are replaced independently one or more other triangles being replaced.

In some embodiments, the additional vertex 1041 (or 1141) is determined based on an average vertex V avg calculated by averaging the positions of vertices 1021 (or 1121) of the at least one triangle being replaced.

For example, the at least one triangle comprises one triangle and the average vertex V_{avg} is calculated by averaging the positions of the three vertices 1021 (or 1121) of one triangle being replaced.

For example, the at least one triangle comprises a pair of triangles and the average vertex V_{avg} is calculated by averaging the positions of four vertices 1021 (or 1121) of the pair of adjacent triangles being replaced.

In some embodiments, the additional vertex 1041 (or 1141) is determined based on a weighted average vertex V_{w,avg} calculated as a weighted sum of the positions of vertices 1021 (or 1121) of the at least one triangle being replaced.

For example, the at least one triangle comprises one triangle and the additional vertex 1041 (or 1141) is determined based on a weighted sum of the positions of the three vertices 1021 (or 1121) of one triangle being replaced.

For example, the at least one triangle comprises a pair of triangles and the additional vertex 1041 (or 1141) is determined as a weighted sum of the positions of four vertices 1021 (or 1121) of the pair of adjacent triangles (e.g., two triangles sharing a common edge) being replaced.

In some embodiments, weights used to calculate the weighted sum of the positions of vertices 1021 are determined based on distances between the positions of the vertices 1021 of the at least one triangle being replaced and an averaged vertex V_{avg} calculated by averaging of the positions of vertices 1021 of the at least one triangle being replaced.

In some embodiments, the weights are inverse proportional to the distances. The farther the vertices, the lower the weight values.

In some embodiments, the additional vertex 1041 (or 1141) (V_{add}) may be further determined by adding a residual vector Vᵣₑₛ to the average vertex V_{avg}.

In some embodiments, the average vertex V_{avg} is displaced by a residual vector Vᵣₑₛ to obtain the additional vertex V_{add}. For example, the residual vector Vᵣₑₛ may be determined as a product of a scalar residual value V_{res,1D} and a unitary normal vector \vec{n}

$${V}_{add} = {V}_{avg} + {V}_{res} = {V}_{avg} + {V}_{res , 1 D} \cdot \vec{n}$$

In some embodiments, the additional vertex 1041 (or 1141) (V_{add}) may be determined further by adding a residual vector Vᵣₑₛ to the weighted average vertex V_{w,avg}.

In some embodiments, the weighted average vertex V_{w,avg} is displaced by a residual vector Vᵣₑₛ to obtain the additional vertex V_{add}, the residual vector Vᵣₑₛ being a product of a scalar residual value V_{res,1D} and a unitary normal vector:

$${V}_{add} = {V}_{w , avg} + {V}_{res} = {V}_{w , avg} + {V}_{res , 1 D} \cdot \vec{n}$$

The coding in the bitstream of the residual vectors Vᵣₑₛ may require a high number of bits and may reduce the coding efficiency of the encoding and decoding process of FIGS. 10A, 10B, 11A, and 11B. The scalar residual value requires less bits to code in the bitstream than a 3D residual vector and compression capability of the encoding and decoding process of FIGS. 10A, 10B, 11A, and 11B is improved.

In some embodiments, the unitary normal vector is determined based on normal vectors to second triangles defined by pivoting around the average vertex V_{avg} or weighted average vertex V_{w,avg} and pairs of adjacent vertices of the at least one triangle, the pairs of adjacent vertices of the at least one triangle stands for vertices of the at least one triangle connected by an edge.

In some embodiments, a normal vector, of the normal vectors, for a respective second triangle of the second triangles is determined as a vector cross product of two edges of the respective second triangles.

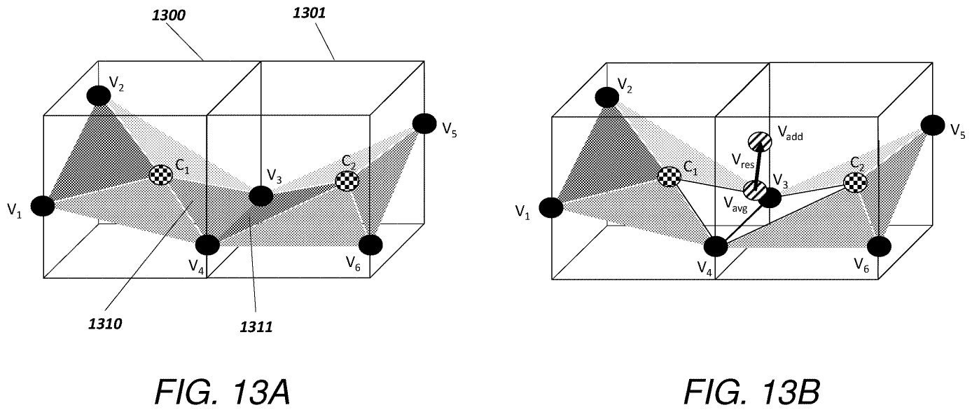

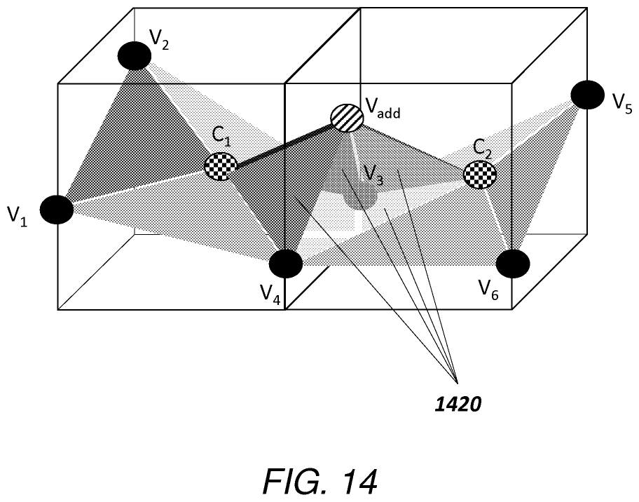

For example, as illustrated in FIG. 13B, the average vertex V_{avg} is determined as a weighted sum of the vertices V₃, V₄, C₁, C₂ of the pair of triangles 1310 and 1311 being replaced. A normal vector N may then be determined by the sum of cross products

$$\vec{N} = \vec{{V}_{4} {V}_{avg}} \times \vec{{C}_{1} {V}_{avg}} + \vec{{C}_{1} {V}_{avg}} \times \vec{{V}_{3} {V}_{avg}} + \vec{{V}_{3} {V}_{avg}} \times \vec{{C}_{2} {V}_{avg}} + \vec{{C}_{2} {V}_{avg}} \times \vec{{V}_{4} {V}_{avg}} ,$$

and the unitary vector \vec{n} is the normalized vector

$$\vec{n} = \vec{N} / ‖ \vec{N} ‖ .$$

The vector \vec{n} is thus indicative of the direction normal to a local surface defined by the portion of the point cloud. The unitary vector \vec{n} does not need to be coded in the bitstream 1090 (or decoded from the bitstream 1190) as it can be reciprocally computed by both encoder and decoder.

In some embodiments, the scalar residual value V_{res,1D} may be determined by the encoder. For example, in some embodiments, the scalar residual value V_{res,1D} may be determined by the encoder as the intersection between the portion of the point cloud and a line.

In some embodiments, the line may intersect the average vertex V_{avg}.

In some embodiments, the line may intersect the weighted average vertex V_{w,avg}.

In some embodiments, the line may intersect the unitary normal vector \vec{n}.

In some embodiments, the scalar residual value V_{res,1D} may be encoded in the bitstream by the encoder.

Relatedly, in some embodiments, the scalar residual value V_{res,1D} may be decoded from the bitstream by the decoder.

In some embodiments, the scalar residual value V_{res,1D} may be determined as a mean value along the line of projected points on the line. In some embodiments, the scalar residual value V_{res,1D} may be determined as a weighted mean value along the line of projected points on the line. In some embodiments, the weights (in the weighted mean) may depend on the distance of the closest points from the line.

In some embodiments, the points projected on the line may be the closest points, of the portion of the point cloud, relative to the line.

In some embodiments, the scalar residual values V_{res,1D} may be quantized.

In some embodiments, the scalar residual value V_{res,1D} may be binarized and entropy encoded in the bitstream 1090 by a binary entropy coder. In some embodiments, the scalar residual value V_{res,1D} may be entropy decoded from the bitstream 1190 by a binary decoder.

In some embodiments, the decoded scalar residual value V_{res,1D} may be inverse quantized (e.g., dequantized). For example, scalar residual values V_{res,1D} may be uniformly quantized and the decoded scalar residual value V_{res,1D} may be uniformly inverse quantized. By doing so, the quantization error is uniform over all additional vertices V_{add} such that the local surface is uniformly approximated.

In some embodiments, the additional vertex information further indicates the residual vector Vᵣₑₛ. In some embodiments, the additional vertex information may include an indication (e.g., binary flag or syntax element) indicating whether the residual vector is a null residual vector (e.g., whether the residual vector is zero). In some embodiments, the additional vertex information may further indicate a sign of the residual vector. In some embodiments, the additional vertex information may further indicate a magnitude of the residual vector. For example, an indication of the sign and an indication of the magnitude may be signaled as additional vertex information when the null residual vector is not indicated (i.e., the residual vector is not zero).

In some embodiments, the additional vertex information may indicate a sign and a magnitude of the residual vector without including an indication of whether the residual vector is zero or a null residual vector.

In some embodiments, the magnitude of the residual vector indicates a true magnitude minus 1. For example, if the indication of the residual vector being non-null (or non-zero) is signaled, then the true magnitude of the residual vector is at least 1 so the magnitude indicated in the additional vertex information may be the true magnitude minus 1.

In some embodiments, the residual vector Vᵣₑₛ may be indicated in the additional vertex information as a scalar residual value V_{res,1D}. For example, in some embodiments, the additional vertex information further indicates whether the scalar residual value V_{res,1D} is null. In some embodiments, the additional vertex information further indicates a sign of the scalar residual value V_{res,1D}. In some embodiments, the additional vertex information further indicates a magnitude of the scalar residual value V_{res,1D}. As explained above, the magnitude of the scalar residual value V_{res,1D} may indicate a true magnitude minus 1.

In some embodiments, the at least one of the set of triangles is iteratively replaced with further triangles until a stopping criterion is satisfied. In some embodiments, a stopping criterion is satisfied when a maximum number of iterations is reached. For example, the maximum number can be 0 to indicate that triangles are not iteratively replaced. Any other value can also be used. In some embodiments, the stopping criterion is evaluated based on the portion of point cloud geometry represented by the at least one triangle being replaced.

In some embodiments, the stopping criterion is satisfied when a quality of approximation of the portion of the point cloud by the further triangles obtained by iteratively replacing the at least one triangle is below a threshold. In some embodiments, the quality of approximation of the portion of the point cloud by the further triangles is based on a rate distortion optimization cost evaluated to encode the portion of the point cloud based on the further triangles.

In some embodiments, the threshold may be predetermined.

In some embodiments, the additional vertex information may further indicate the threshold. For example, the additional vertex information may further indicate a null threshold. For example, the additional vertex information may further indicate a magnitude of the threshold. As explained above, if a null indication of the threshold is indicated (e.g., such as explained for the residual vector), then the magnitude indicated for the threshold may indicate a true value of the threshold minus 1.

In some embodiments of a process of FIGS. 10A, 10B, 11A, and 11B, one triangle is replaced independently of one or more other triangles being replaced. The triangle replacement information 1042 and 1142 may then indicate the at least one triangle comprises one triangle.

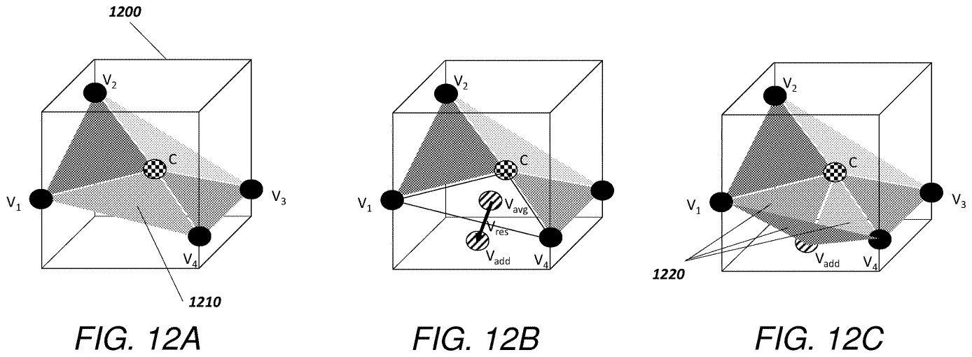

FIGS. 12A-C illustrates an example of the replacement of a TriSoup triangle 1210 belonging to a TriSoup node 1200, according to some embodiments.

Four TriSoup vertices V₁ to V₄ belonging to edges of the TriSoup node 1200 are illustrated as well as a centroid vertex C (e.g., average vertex calculated from the four vertices V₁ to V₄) within the TriSoup node 1200. Four TriSoup triangles are thus obtained from the four TriSoup vertices V₁ to V₄ by pivoting around the centroid vertex C, namely triangles V₁V₂C, V₂V₃C, V₃V₄C and V₄V₁C. The replacement of the fourth TriSoup triangle 1210 (e.g., defined by vertices V₄V₁C) is illustrated through FIG. 12B and FIG. 12C. Firstly, as shown in FIG. 12B, an additional vertex V_{add} is determined from the TriSoup vertices V₄, V₁ and the centroid vertex C. For example, the additional vertex V add may be an average vertex V_{avg} calculated by averaging the positions of the two TriSoup vertices V₄, V₁ et the centroid C or calculated as a weighted sum of the positions of the two TriSoup vertices V₄, V₁ and the centroid C. In a variant, the additional vertex V_{add} may also be determined by adding a residual vector Vᵣₑₛ to the average vertex V_{avg} (or weighted average vertex V_{w,avg}). Then, as shown in FIG. 12C, three further triangles 1220 are determined from the TriSoup vertices V₄, V₁ et the centroid C by pivoting around the additional vertex V_{add}. The further triangles 1220 are namely V₄V₁V_{add}, V₁CV_{add} and CV₄V_{add}. The three further triangles 1220 replace the TriSoup triangle 1210 in the set of triangles.

In some embodiments, in processes of FIGS. 10A, 10B, 11A, and 11B, a pair of adjacent triangles is replaced independently of one or more other triangles being replaced. The triangle replacement information 1042 and 1142 may then indicate the at least one triangle comprises a pair of adjacent triangles.

In some embodiments, a pair of adjacent triangles may be two triangles sharing a common edge.

FIG. 13A, FIG. 13B, and FIG. 14 illustrate examples of the replacement of a pair of TriSoup triangles 1310,1311 belonging to two TriSoup nodes 1300 and 1301, according to some embodiments. Six TriSoup vertices V₁ to V₆ belonging to edges of the two TriSoup nodes 1300 and 1301 are illustrated as well as two centroid vertices C₁ and C₂ within each of the two TriSoup nodes 1300 and 1301. Eight TriSoup triangles are thus obtained by pivoting around the two centroid vertices C₁ and C₂, namely triangles V₁V₂C₁, V₂V₃C₁, V₃V₄C₁, V₄V₁C₁, V₄V₃C₂, V₃V₅C₂, V₅V₆C₂ and V₆V₄C₂. The replacement of the two TriSoup triangles V₃V₄C₁ (1310) and V₄V₃C₂ (1311) is illustrated through FIG. 13B and FIG. 14. The common replacement of these two triangles is allowed because they are adjacent i.e., they share a common edge V₄V₃. Firstly, as shown in FIG. 13B, an additional vertex V_{add} is determined from the TriSoup vertices V₃ and V₄ and the centroid vertices C₁ and C₂. For example, the additional vertex V_{add} may be an average vertex V_{avg} calculated by averaging the positions of the TriSoup vertices V₃ and V₄ and the centroid vertices C₁ and C₂ or calculated as a weighted sum of the positions of the TriSoup vertices V₃ and V₄ and the centroid vertices C₁ and C₂. In a variant, the additional vertex V_{add} may also be determined by adding a residual vector Vᵣₑₛ to the average vertex V_{avg} (or weighted average vertex V_{w,avg}). Then, as shown in FIG. 14, four further triangles 1420 are obtained by pivoting around the additional vertex V_{add} and by using the TriSoup vertices V₃, V₄ and the centroid vertices C₁ and C₂; the further triangles are namely V₄C₁V_{add}, C₁V₃V_{add}, V₃C₂V_{add} and C₂V₄V_{add}. The four further triangles 1420 replace the two TriSoup triangles 1310 and 1311 in the set of triangles.

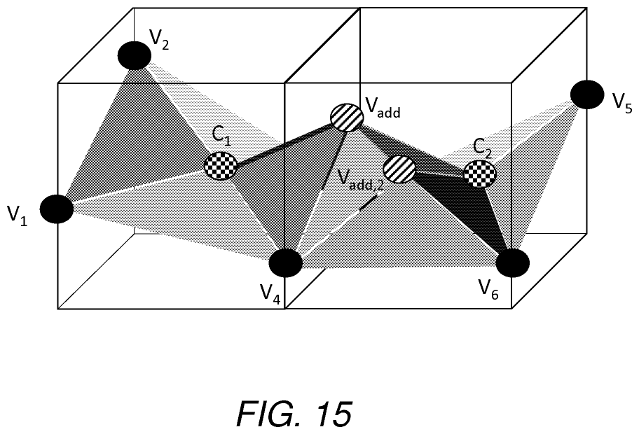

FIG. 15 illustrates an example of an iterative replacement of TriSoup triangles, according to some embodiments.

In this example, the pair of triangles 1310,1311 of FIG. 13A are replaced with four further triangles 1420 (V₄C₁V_{add}, C₁V₃V_{add}, V₃C₂V_{add} and C₂V₄V_{add}, as shown in FIG. 14). The pair of triangles C₂V₄V_{add} and V₆V₄C₂ (TriSoup triangle) are then replaced with further triangles V₆V₄V_{add,2}, V₄V_{new} V_{add,2}, V_{add}C₂V_{add,2} and C₂V₆V_{add,2} that replace the pair of triangles C₂V₄V_{add} and V₆V₄C₂ in the set of triangles. The further triangles V₆V₄V_{add,2}, V₄V_{add}V_{add,2}, V_{add}C₂V_{add,2} and C₂V₆V_{add,2} are obtained by pivoting around an additional vertex V_{add,2}. The additional vertex V_{add,2} may be an average vertex V_{avg} calculated by averaging the positions of the vertices V₄, V_{add}, V₆ and C₂ or calculated as a weighted sum of the vertices V₄, V_{add}, V₆ and C₂. In a variant, the additional vertex V_{add,2} may also be determined by adding a residual vector Vᵣₑₛ to the average vertex V_{avg} (or weighted average vertex V_{w,avg})

In some examples, coding the triangle replacement information 1032 or 1132 for each triangle or pair of adjacent triangles may be costly. An eligibility criterion may be used to automatically discard, without signaling, some triangles from the replacement process of FIGS. 10A, 10B, 11A, and 11B.

In some embodiments, the at least one triangle is replaced based on satisfying an eligibility criterion.

In some embodiments, the eligibility criterion is satisfied when an area of the at least one triangle is higher than a first threshold thₐ. In other words, triangle having an area lower than the threshold thₐ are removed from the set of triangles being replaced.

In some embodiments, the additional vertex information further indicates the first threshold. In some embodiments, the additional vertex information further indicates a null first threshold. In some embodiments, the additional vertex information further indicates a sign of the first threshold. In some embodiments, the additional vertex information further indicates a magnitude of the first threshold. In some embodiments, the magnitude of the first threshold indicates a true magnitude minus 1.

In some embodiments, the at least one triangle comprises a pair of adjacent triangles, and the eligibility criterion is satisfied when a length of a common edge shared by the pair of adjacent triangles is higher than a second threshold th_{b}.

In some embodiments, the additional vertex information further indicates the second threshold.

In some embodiments, the additional vertex information further indicates a null second threshold.

In some embodiments, the additional vertex information further indicates a sign of the second threshold. In some embodiments, the additional vertex information further indicates a magnitude of the second threshold. In some embodiments, the magnitude of the second threshold indicates a true magnitude minus 1.

For example, the thresholds thₐ and/or th_{b} may be coded in a Sequence Parameter Set (SPS,) a Geometry Parameter Set (GPS) or in a Geometry Brick Header (GBH).

In some embodiments, the first and second thresholds are known by the decoder beforehand.

In existing technologies, the quality of a decoded point cloud geometry is related to a spatial similarity (e.g., as measured by various distance metrics) between the points (e.g., as represented by voxels) of the decoded point cloud (decoded point cloud geometry) and the points of the original point cloud (point cloud geometry). For point cloud geometry coded using a TriSoup model (e.g., TriSoup scheme), the quality of a decoded point cloud geometry depends mainly on the size of TriSoup triangles and the precision of coding of their TriSoup vertices. For example, the TriSoup vertices (e.g., their positions) are typically quantized before coding, which may control a precision of the decoded (e.g., dequantized) TriSoup vertices at the decoder. Smaller sizes for the TriSoup triangles and/or finer quantization of the TriSoup vertices lead to a better quality of the decoded point cloud geometry, but at the price of a larger bitstream for coding the TriSoup related information because there are more TriSoup vertices with higher precision to be coded.

The set of TriSoup triangles (e.g., resulting from applying the TriSoup model) is a linear approximation of the surface defined (e.g., represented) by the point cloud geometry. The local error of the approximation typically depends on the distance between the surface from the interpolation points which are the TriSoup vertices. Therefore, smaller TriSoup triangles may more closely approximate the surface, which results in reduced error. Because the interpolation points are quantized, the local error may further depend on the quantization (e.g., quantization size) of the TriSoup vertices. The amount of bits in the bitstream to code the set of TriSoup vertices increases proportionally to the number of coded TriSoup vertices (e.g., resulting from smaller TriSoup triangles) and decreases when the size of the quantization step increases. Consequently, lower distortion D of the approximation is obtained by smaller distance between TriSoup vertices (thus a higher number of TriSoup vertices) and smaller quantization steps, but this leads to an increase of the bitrate R for coding the TriSoup vertices.

The cost of coding may be a rate-distortion optimization (RDO) cost that is typically expressed as a combination D+λ R of distortion and bitrate, where λ is a so-called Lagrange parameter whose value, typically set by the user, tunes the balance between quality and bitrate. Lower values of λ favor high quality and high bitrate, on the other hand higher values of λ favor low quality and low bitrate. For a given Lagrange parameter λ, the optimal trade-off quality vs bitrate may be obtained by minimizing the cost as a function of the coding parameters. In some examples of the TriSoup model, coding parameters may include edge length L of the triangles of the set of triangles and the quantization step ΔQ of the position of the (TriSoup) triangle vertices. For example, the quantization step ΔQ may be used for quantizing the positions of TriSoup vertices along TriSoup edges and for quantizing the scalar residual values (αᵣₑₛ) of refined centroid vertices (C+Cᵣₑₛ).

In some examples, coding parameters may be set (e.g., configured) globally for the entire point cloud geometry, or for a slice (e.g., equivalently brick or data unit) level that typically covers a large volume encompassing a significant portion of the point cloud. Therefore, local quality of the decoded point cloud geometry can only be adjusted by increasing the number of slices, but this leads to an unacceptable increase of the bitrate due to the coding of a high number of slice headers and the inability to perform efficient spatial prediction between slices.

Embodiments of the present disclosure are related to the use of quality units to partition a volume of the point cloud geometry into sub-volumes (corresponding to the quality units) such that the quality of a decoded point cloud geometry may be controlled (e.g., adjusted) locally for portions of the point cloud geometry as defined by the quality units (e.g., occupied or activated quality units). For example, quality units may partition the volume encompassing the entire point cloud or to partition a volume of the slice (e.g., brick or data unit) encompassing a large portion of the point cloud. The use of quality units to control local quality may enable an overall targeted bitrate for the coded point cloud geometry while balancing the allocation of bits between different sub-volumes encompassing portions of the point cloud. This balancing is useful to optimize the visual quality under the constraint of a maximum targeted bitrate, for example, imposed by a transmission channel. Thus, sub-volumes that encompass (e.g., contains) regions of interest (ROI) may be coded with higher quality (thus more bits) compared to other sub-volumes. For example, ROI may be the face of a person, skin, players and balls on a field, subtitles, etc. Other sub-volumes may be a smooth background, a crowd, or fast-motion portions of the point cloud that can be selectively indicated by quality units to be coded with less quality, thus reducing bits.

In some embodiments, the volume encompassing a point cloud geometry may be partitioned into non-overlapping partitions of quality units. A decoder may decode, from a bitstream, quality unit information indicating these quality units that partition the volume of the point cloud geometry. The decoder may determine, based on the decoded quality unit information and from the quality units, occupied quality units each containing a portion of the point cloud geometry. The decoder may decode, from the bitstream and based on at least one local quality parameter associated with each occupied quality unit, point cloud information corresponding to a portion of the point cloud geometry contained in each occupied quality unit. Then, the decoder may reconstruct the portion of the point cloud geometry based on the decoded point cloud information. Accordingly, different local quality parameters may be determined and associated with different occupied quality units, to permit different portions of the point cloud geometry to be coded with different quality.

Because the points (e.g., decoded and reconstructed as voxels) of a point cloud belong to a 3D space that is mainly empty, a topology of potential quality units may be set a priori by a partition of the 3D space, for example into cubic blocks having a same size, but not all potential quality units will contain a point (voxel) of the point cloud. A quality unit may then be either an unoccupied quality unit (e.g., deactivated quality unit) or an occupied quality unit (e.g., activated quality unit). A quality unit may be an occupied quality unit when it comprises a portion of the point cloud geometry (i.e., at least one point of the point cloud), and a quality unit is an unoccupied quality unit when it does not comprise any portion (e.g., any point) of the point cloud.

In some embodiments, the quality unit information includes a space-partitioning tree (e.g., also referred to as an occupancy tree as described below) that partitions the volume of the point cloud geometry into (e.g., non-overlapping) sub-volumes corresponding to nodes of the space-partitioning tree. For example, leaf nodes of the space-partitioning tree may indicate which sub-volumes, of the volume, contain at least a portion (e.g., at least a point) of the point cloud geometry. Thus, the space-partitioning tree links (e.g., associates) sub-volumes with quality parameters coding portions of the point cloud geometry contained in sub-volumes. Examples of the type of space-partitioning tree may include binary space partitioning (BSP) tree, a bounding hierarchy volume (BHV) tree, a k-dimensional (k-d) tree, a quadtree, or an octree, etc.

In some embodiments, the space-partitioning tree may be determined based on an occupancy tree for coding TriSoup nodes (of the TriSoup model) used to represent the point cloud geometry. For example, a quality unit may be determined to be an occupied quality unit based on that quality unit containing at least a portion of one or more TriSoup nodes as coded by the occupancy tree coding the point cloud geometry. However, the space-partitioning tree (e.g., the occupancy tree for coding point cloud quality) is not necessarily aligned with the occupancy tree for coding point cloud geometry. For example, an occupied quality unit may comprise more than one TriSoup node as represented in the occupancy tree coding the point cloud geometry. For example, an occupied quality unit may partially comprise (e.g., contain only a portion of) one or more TriSoup nodes as represented in the occupancy tree coding the point cloud geometry. In some examples, quality units may be generally larger than TriSoup nodes to reduce signaling overhead since quality does not necessarily need to be specified at a TriSoup node granularity. In such examples and in various other implementations, the quality units (whose activation/occupation may be based on the occupancy tree for coding point cloud geometry) may be decoupled and separately coded from the coding of the occupancy tree for the point cloud geometry (e.g., coding TriSoup nodes).

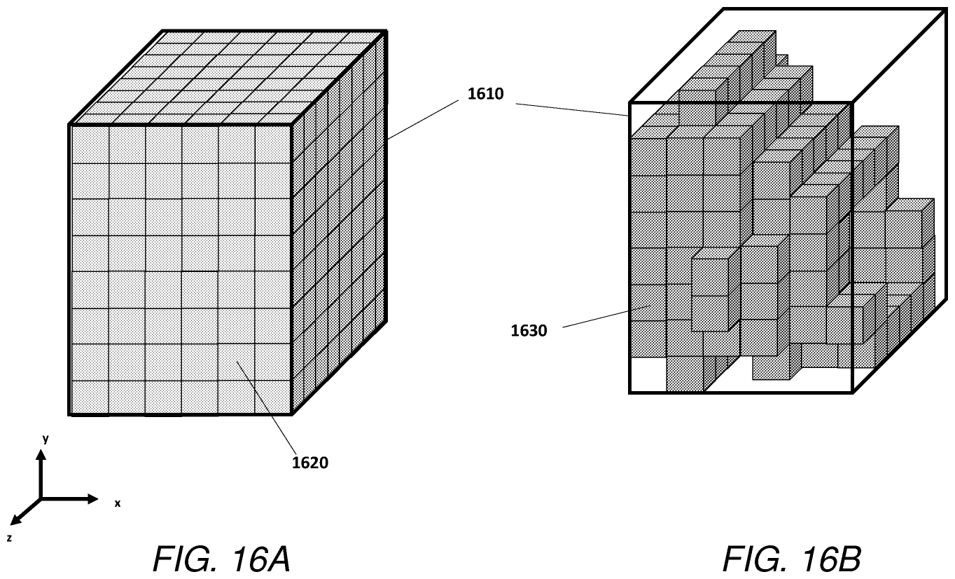

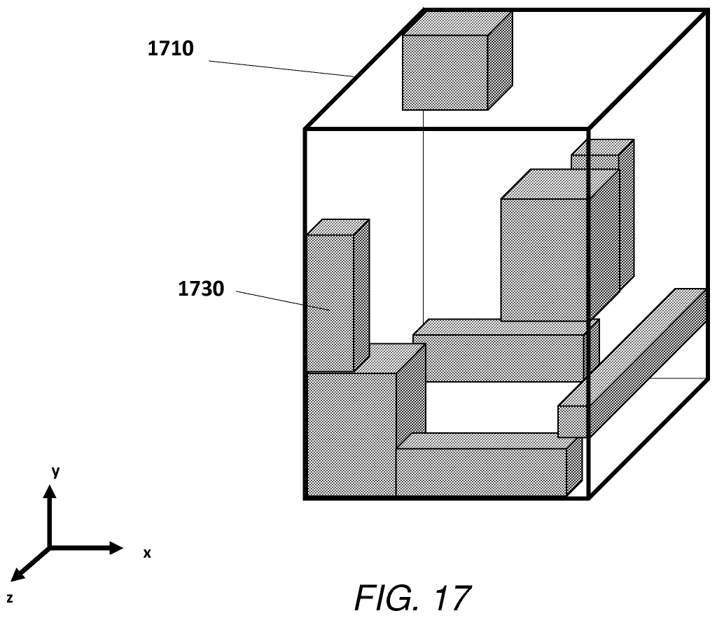

FIG. 16A and FIG. 16B illustrate an example of occupied quality units obtained from an occupancy octree, according to some embodiments. As explained above, quality units may be coded with other types of spatial-partitioning/occupancy trees such as a binary space partitioning (BSP) tree, a bounding hierarchy volume (BHV) tree, a k-dimensional (k-d) tree, a quadtree, etc.

A volume 1610 encompasses a point cloud geometry and the volume 1610 may be partitioned into non-overlapping quality units 1620 according to the occupancy tree, e.g., an octree in which each cuboid is split into eight sub-cuboids all with the same size and shape at a given depth level of the occupancy tree. Only quality occupied units 1630 corresponding to occupied nodes of the occupancy octree are shown on FIG. 16B. Each quality occupied unit contains at least one point of the point cloud geometry.

In some embodiments, quality units 1620 may correspond to TriSoup nodes as coded in an occupancy tree coding point cloud geometry, as described in FIGS. 2-4. However, in some embodiments, the sizes of quality units are different (e.g., generally larger, but may be smaller in some examples) from the TriSoup node sizes. For example, each of quality occupied units 1630 may contain a portion of the cloud geometry as represented by one or more (or a portion/partial of) TriSoup nodes.

FIG. 17 illustrates an example of occupied quality units obtained from a KD-tree, which is a different spatial-partitioning tree (e.g., occupancy tree) as that shown in FIGS. 16A-B, KD according to some embodiments.

A volume 1710 encompasses a point cloud geometry and the volume 1710 is partitioned into non-overlapping quality units according to the KD-tree such that each cuboid is split into two sub-cuboids. Only occupied quality units 1730 corresponding to occupied nodes of KD tree are shown on FIG. 17. Each occupied quality unit contains at least one point of the point cloud geometry.

Similarly, as explained above in FIGS. 16A-B, the spatial-partitioning tree (e.g., occupancy tree) for coding quality units may be different in type or size from the occupancy tree for coding TriSoup nodes. For example, FIG. 17 shows a KD-tree for coding the quality units whereas TriSoup nodes are coded (e.g., represented) by an occupancy octree.

In some embodiments, quality units that partition a volume encompassing a point cloud geometry are determined. Occupied quality units each containing a portion (e.g., a point) of the point cloud geometry are also determined from the quality units. Quality unit information is encoded in the bitstream to indicate the quality units (that partition the volume encompassing the point cloud geometry) and to indicate the occupied quality units from the quality units. Point cloud information corresponding to a portion of the point cloud geometry contained in each occupied quality unit is encoded in the bitstream based on at least one local quality parameter associated with each occupied quality unit.

The quality of the decoded point cloud geometry may be adjusted locally because the decoding of a portion of the point cloud geometry contained in an occupied quality unit may be based on at least one local quality parameter value that is dedicated to the decoding of the portion of the point cloud. Different local quality parameter values may then be determined (or signaled in the bitstream) for the occupied quality units to obtain different qualities of the decoded portions of the point cloud contained in the occupied quality units.

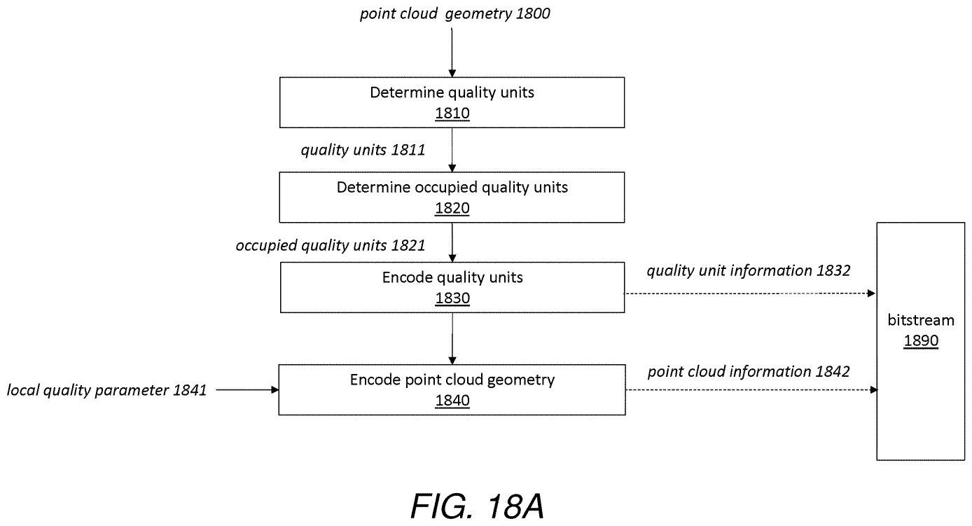

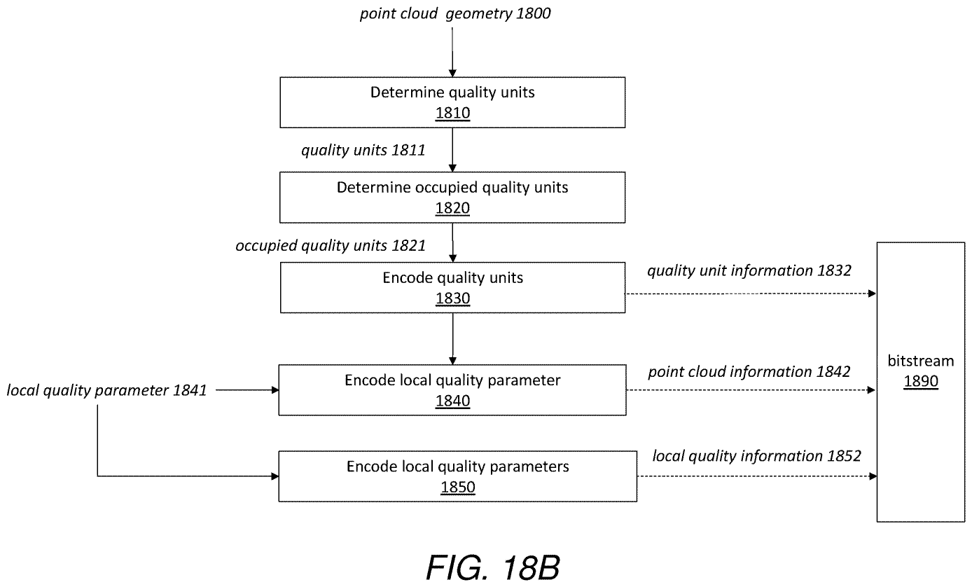

FIG. 18A illustrates an example process for encoding in a bitstream 1890 a point cloud geometry 1800, according to some embodiments. For example, the process of FIG. 18A may be performed by an encoder (e.g., encoder 114 of FIG. 1). In some examples, blocks 1810, 1820, 1830, and 1840 may represent components within the encoder.

At block 1810, quality units 1811 that partition a volume encompassing a point cloud geometry are determined. In some examples, the encoder may apply (e.g., generate) a space-partitioning tree (e.g., an occupancy tree) to partition the volume into sub-volumes corresponding to quality units. Nodes (e.g., leaf nodes) of the space-partitioning tree may indicate the quality units.

At block 1820, occupied quality units 1821, each containing a portion (e.g., a point) of the point cloud geometry, are determined from the quality units 1811. In some examples, occupied quality units 1821 may be determined based on an occupancy tree for coding point cloud geometry, as explained above in FIGS. 2-4. In some examples, in which the space-partitioning tree is used to generate quality units 1811, a portion of the leaf nodes of the space-partitioning tree may be determined to indicate sub-volumes (of the volume) corresponding to the occupied quality units 1821.

At block 1830, quality unit information 1832 indicating the quality units 1811 (that partition the volume encompassing the point cloud geometry 1800) and indicating the occupied quality units 1821 from the quality units 1811 is encoded in the bitstream 1890. For example, quality unit information 1832 may be encoded as the space-partitioning tree, as described at block 1820. In some examples, the space-partitioning tree has leaf nodes that are associated with occupied quality units or non-occupied quality units.

At block 1840, point cloud information 1842, corresponding to a portion of the point cloud contained in each occupied quality unit, is encoded in the bitstream 1890 based on at least one local quality parameter 1841 associated with each occupied quality unit. Examples of the at least one local quality parameter 1841 are further described below.

FIG. 18B illustrates another example process for encoding in a bitstream a point cloud geometry, according to some embodiments. For example, the process of FIG. 18B may be performed by an encoder (e.g., encoder 114 of FIG. 1). The process of FIG. 18B may include the same operations (shown as having the same labeled blocks) as those described in FIG. 18A. Different from the process of FIG. 18A, the process of FIG. 18B includes block 1850. In some examples, block 1850 may represent a component within the encoder. At block 1850, the at least one local quality parameter 1841 associated with each occupied quality unit 1821, is encoded in the bitstream 1890. Examples of the at least one local quality parameter 1841 are further described below.

In some embodiment, the at least one local quality parameter 1841 is encoded in the bitstream 1890 as local quality information 1852.

In some embodiment, the at least one local quality parameter is encoded in the bitstream 1890 as point cloud information 1842.

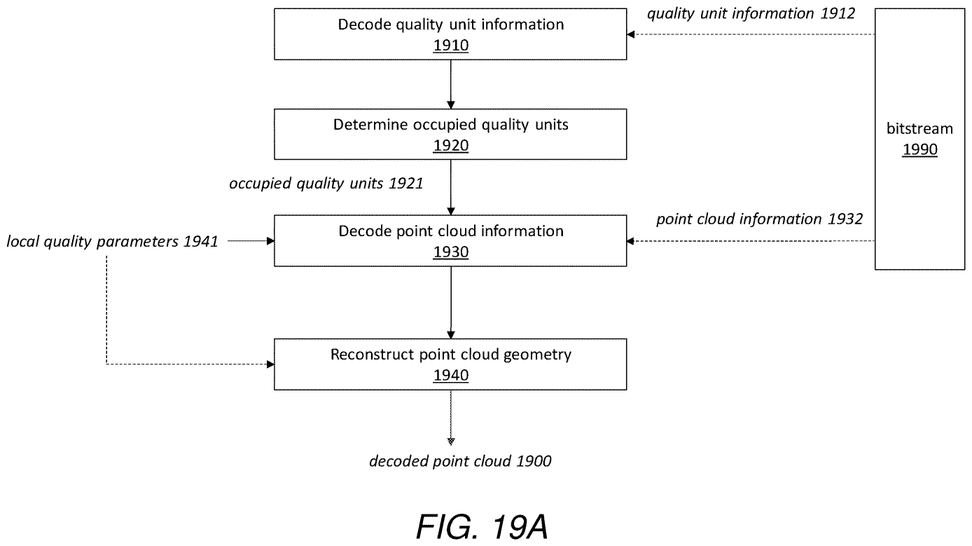

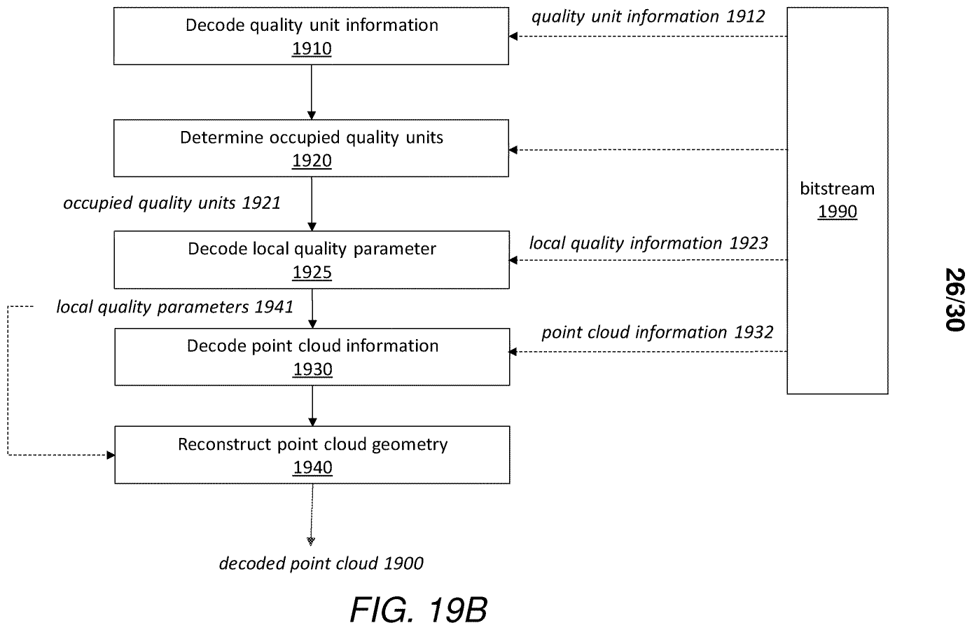

FIG. 19A illustrates an example process for decoding from a bitstream 1990 a point cloud geometry, according to some embodiments. For example, the process of FIG. 19A may be performed by a decoder (e.g., decoder 120 of FIG. 1).

At block 1910, quality unit information 1912, indicating quality units that partition a volume encompassing a point cloud geometry, is decoded from the bitstream 1990. In some examples, quality unit information 1912 corresponds to the quality unit information 1832 encoded at block 1830 of FIGS. 18A-B.

At block 1920, occupied quality units 1921, each containing at least a portion of the point cloud geometry, are determined based on the decoded quality units. For example, a quality unit may be determined as one of the occupied quality units 1921 based on the quality unit indicating a sub-volume (of the volume) that contains at least one point of the point cloud geometry.

At block 1930, point cloud information 1932, corresponding to a portion of the point cloud geometry contained in each occupied quality unit 1921, is decoded from the bitstream 1990 and based on at least one local quality parameter 1941 associated with each occupied quality unit 1921. For example, point cloud information 1932 corresponds to point cloud information 1842 encoded at block 1840 of FIG. 18A and FIG. 18B. The at least one local quality parameter 1941 may correspond to the at least one local quality parameter 1841 of FIGS. 18A-B. For example, at least one local quality parameter 1941 may include one or more triangle replacement/refinement parameters and/or one or more quantization parameters for decoding vertices, etc. Examples of the at least one local quality parameter 1941 are further described below.

At block 1940, the portion of the point cloud geometry, associated with each occupied quality unit, is reconstructed based on the decoded point cloud information.

In some embodiments, reconstructing the portion of the point cloud associated with an occupied quality unit may include determining voxels of the portion of the point cloud obtained by voxelizing triangles, as explained in FIGS. 9A-B.

In some embodiments, the reconstructing of the portion of the point cloud may be further based on at least one local quality parameter 1941 associated with each occupied quality unit 1921. For example, at least one local quality parameter 1941 may include one or more voxelization parameters.

Therefore, the quality of the decoded point cloud 1900 may vary depending on the values of the at least one local quality parameter 1941 associated with occupied quality units 1921.

FIG. 19B illustrates another example process for decoding from the bitstream 1990 a point cloud geometry, according to some embodiments. For example, the process of FIG. 19B may be performed by a decoder (e.g., decoder 120 of FIG. 1). The process of FIG. 19B may include the same operations (shown as having the same labeled blocks) as those described in FIG. 19A. Different from the process of FIG. 19A, the process of FIG. 19B includes block 1925. In some examples, block 1925 may represent a component within the decoder. At block 1925, the at least one local quality parameter 1941, associated with each occupied quality unit 1921, is decoded from the bitstream 1990. For example, at least one local quality parameter 1941 may be decoded for each of occupied quality units 1921. In some examples, at least one local quality parameter 1941 may be decoded for a subset (e.g., one or a group of two or more) of occupied quality units 1921.

In some embodiment, the at least one local quality parameter 1941 is derived by decoding local quality information 1923 from the bitstream 1990.

In some embodiment, the at least one local quality parameter 1941 is derived by decoding point cloud information 1932 from the bitstream 1990.

Various examples of the quality unit information and the at least one local quality parameter described in FIGS. 18-19 are provided below.

In some embodiments, the at least one local quality parameter may be based on at least one user parameter controlling a decision of a targeted local visual quality for the portion of the point cloud geometry comprised in each occupied quality unit.

In some embodiments, the at least one local quality parameter may then be determined based on the targeted local visual quality and/or restriction on local bitrate allocation.

In some embodiments, the point cloud geometry may be encoded/decoded based on a TriSoup geometry scheme, as discussed above. The quality unit information 1832 and/or 1912) may indicate an occupancy tree (e.g., spatial-partitioning tree) representing a partition of a volume of (e.g., containing or encompassing) the point cloud geometry 1800. The quality units may be determined based on leaf nodes of the occupancy tree, and the quality unit information 1832 and/or 1912) may further indicate the occupied quality units that are determined based on occupied leaf nodes of the occupancy tree. Each of the occupied leaf nodes may contain a portion (e.g., at least one point) of the point cloud geometry.

In some embodiments, the encoding of the point cloud geometry may comprise determining triangle vertices, belonging to each occupied quality unit 1821, based on at least one local quality parameter 1841 associated with each occupied quality unit 1821. Further, the point cloud information 1842, representing the triangle vertices, may be encoded in bitstream 1890 based on at least one local quality parameter 1841 associated with each occupied quality unit 1821.

In some embodiments, point cloud information 1932, representing triangle vertices, is decoded from the bitstream 1990 based on at least one local quality parameter 1941 associated with each occupied quality unit. The decoded (reconstructed) portion of the point cloud may be obtained (e.g., determined) by voxelizing triangles constructed from the triangle vertices.

In some embodiments, occupied quality unit 1821 and 1921 (and associated at least one local quality parameter 1841 and 1941) specify how contained portions (e.g., vertices) of the point cloud geometry are to be encoded/decoded, but not the ordering or representations of those portions. The ordering and representations of portions of the point cloud geometry may be specified (e.g., encoded and/or decoded) using an occupancy tree (e.g., an octree) for coding the point cloud geometry, as described in FIGS. 2-4.

In some embodiments, the occupied quality units 1821 and/or 1921 may be further determined based on at least one parameter in quality unit information.

In some embodiments, the quality unit information may further indicate the topology of quality units. For example, the quality unit information may indicate a type of spatial-partitioning tree (e.g., an occupancy tree) used to partition a volume containing a point cloud geometry to determine the quality units.

In some embodiments, the quality unit information may further indicate at least one shape of the occupied quality units. In some embodiments, the at least one shape may be a cuboid.

In some embodiments, the quality unit information may further indicate at least one dimension of the occupied quality units.

In some embodiments, the quality unit information may further indicate the partition in quality units of the volume encompassing the point cloud and may further indicate whether a quality unit of the partition is an occupied quality unit.

In some embodiments, at least one occupied quality unit may comprise at least one or at least a part of one occupied leaf node of an occupancy tree (e.g., one TriSoup node). In some examples where occupied quality units comprise portions of sub-volumes/cuboid indicated by TriSoup nodes, further signaling of the quality unit topology is not needed because the occupied quality units may be derived (e.g., determined) from the occupancy tree coding the point cloud geometry. Local quality information may be associated with (e.g., determined and/or signaled for) each TriSoup node (equivalently to each occupied leaf node of the occupancy tree). Reference to sizes of leaf nodes or portions of point cloud geometry being contained in leaf nodes may indicate the sizes of sub-volumes (e.g., cuboids) indicated by the leaf nodes and the portions of point cloud geometry being contained in those sub-volumes.

In some embodiments, the at least one occupied quality unit may correspond to one occupied leaf node of the occupancy tree.

In some embodiments, the local quality information may be associated with each occupied leaf node corresponding to one occupied quality unit.

In some embodiments, the at least one occupied quality unit may correspond to a set of occupied leaf nodes of the occupancy octree.

In some embodiments, the local quality information may be associated with each set of occupied leaf nodes corresponding to one occupied quality unit.

In some embodiments, the set of occupied leaf nodes may form a cuboid.

In some embodiments, the cuboid size may correspond to a product of a first integer number Nₓ of occupied leaf nodes along a first direction by a second integer number Ny of occupied leaf nodes along a second direction by a third integer number N_{z} of occupied leaf nodes along a third direction.

In some embodiments, the first, second, and third integer values may be equal to a fourth integer value N. For example, the quality unit may be a cube of N×N×N occupied leaf nodes.

In some embodiments, the local quality information may further indicate the first, second and third integer values or the fourth integer value.

In some embodiments, at least one occupied quality unit may correspond to at least one or at least a part of one occupied non-leaf node of an occupancy tree located at some tree level L_{qual} of the occupancy tree. Consequently, quality units may be cuboids corresponding to 2^{nx}*2^{ny}*2^{nz} leaf nodes, or in particular may be cubes corresponding to 2ⁿ*2ⁿ*2ⁿ leaf nodes when the occupancy tree is an octree.

In some embodiments, the at least one occupied quality unit may correspond to one occupied non-leaf node of the occupancy tree.

In some embodiments, the local quality information may be associated with each one occupied non-leaf node corresponding to the one occupied quality unit.

In some embodiments, the at least one quality unit may correspond to a set of one occupied non-leaf nodes of the occupancy octree.

In some embodiments, the local quality information may be associated with each set of occupied non-leaf nodes corresponding to one occupied quality unit.

In some embodiments, the set of occupied non-leaf nodes corresponding to one occupied quality unit may be a cuboid.

In some embodiments, the quality unit information may further indicate the tree level L_{qual} and the at least one occupied quality unit corresponds to at least one occupied non-leaf node at the tree level.

In some embodiments, the quality unit information may further indicate the at least one occupied quality unit at the tree level and may further indicate another of the at least one occupied non-leaf node at a deeper level.

This example may be refined by having occupied quality units not all exactly at the tree level L_{qual}, but instead corresponding to tree nodes located at tree levels deeper than the tree level L_{qual}.

In some embodiments, the quality unit information may further indicate each occupied non-leaf node at the tree level is associated with a tree of quality units.

In some embodiments, the quality unit information may further indicate each occupied non-leaf node at the tree level is associated with a tree of quality units having an occupied non-leaf node at the tree level as largest quality unit and smaller quality units based on occupied non-leaf node at least one deeper level as child nodes.

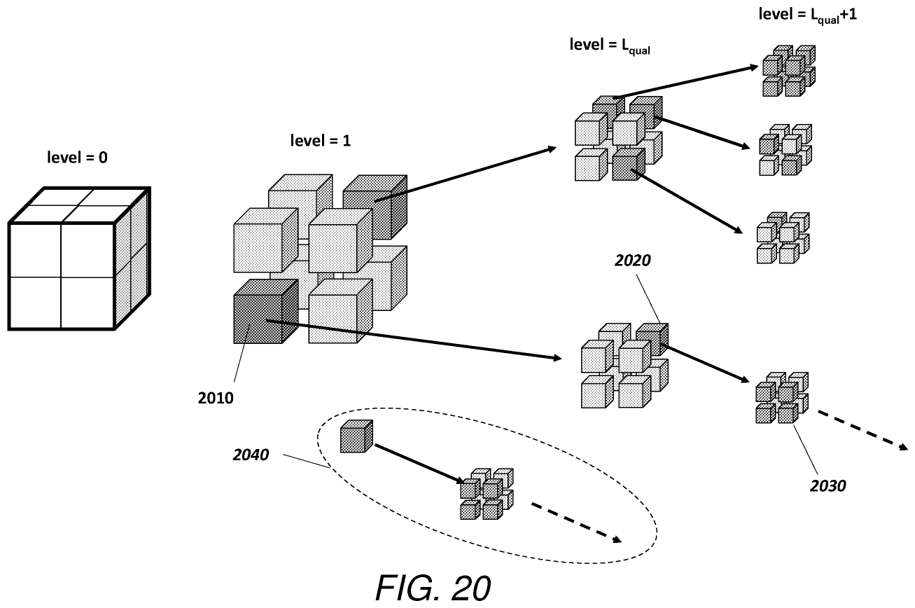

FIG. 20 illustrates an example of an occupied quality unit corresponding to occupied non-leaf nodes at the tree level L_{qual} of the occupancy tree and to occupied non-leaf nodes at a deeper tree level L_{qual}+1, according to some embodiments.

In this example, the occupancy tree is an octree having a root node associated with a cube that is split into eight sub-cubes at level 0. At level 1, a sub-cube 2010 is split into eight sub-cubes at level 2 (L_{qual}). One of the eight sub-cubes at level 2 corresponds to an occupied non-leaf nodes of the occupancy octree and is referred to as a largest quality unit 2020. The largest quality unit 2020 is further split into eight sub-cubes 2030 corresponding to occupied non-leaf nodes (level 3 corresponding to L_{qual}+1). The quality unit information may then indicate the largest quality unit 2020 and sub-cubes 2030 corresponding to occupied non-leaf nodes at level L_{qual}+1. The quality information may indicate the largest quality unit 2020 at level L_{qual} corresponding to a root node of a tree of quality units 2040 containing smaller quality units based on the eight sub-cubes 2030 at level L_{qual}+1 obtained by splitting the largest quality unit 2020 and possibly further sub-cubes obtained by further split each of the eight sub-cubes 2030 at level L_{qual}+1.

In some embodiments, the tree of quality units may associate a quality unit split flag with each node of the tree of quality units 2040 from the tree level L_{qual} to signal the tree of quality units 2040 in a bitstream. Each tree of quality units 2040 may be associated with a tree node at the tree level L_{qual}.

Occupied quality units are tree nodes having a quality unit split flag set to false, and their child nodes have no quality unit split flag. If a tree node has a quality unit split flag set to true, then its occupied child nodes have quality unit split flag signaling the continuation of the tree of quality units. The tree of quality units is thus embedded into the occupancy octree.

In some embodiments, the quality unit information may further indicate the tree level L_{qual} corresponding to largest quality units 2020.

In some embodiments, the quality unit information may further indicate a quality unit split flag indicating a tree of quality units 2040 is associated with the largest quality unit 2020.

As explained above, other types of occupancy trees or spatial-partitioning trees may be used to indicate (and represent) the quality units. For example, besides the occupancy octree, other types of spatial-partitioning trees such as a binary space partitioning (BSP) tree, a bounding hierarchy volume (BHV) tree, a k-dimensional (k-d) tree, a quadtree, etc., may be used.

In some embodiments, the at least one local quality parameter for each occupied quality unit may be a sampling parameter related to a density of voxels in the at least one occupied quality unit. Examples of sampling parameters are described and defined by S. Gao ([GPCC] [EE13.50 related] Improvement of voxelization of TriSoup model, ISO/IEC JTC1/SC29/WG7, m60017, July 2022).

In some embodiments, the at least one local quality parameter for each occupied quality unit may relate to a precision of positions of the triangle vertices belonging to the occupied quality unit. For example, the triangle vertices may include a TriSoup vertex on an edge of a TriSoup node, as described in FIG. 7. For example, the triangle vertices may include a centroid vertex (or an adjusted centroid vertex), as described above in FIGS. 8A-C. For example, the triangle vertices may include an additional vertex derived from previously decoded/reconstructed vertices, as described above in FIGS. 12-15.

In some embodiments, the at least one local quality parameter for each occupied quality unit may relate to voxelization of triangles.

In some embodiments, the at least one local quality parameter may relate to a halo of the decoded portion of the point cloud geometry, as described above in FIG. 9C.

In some embodiments, the at least one local quality parameter may relate to a thickness of the decoded portion of the point cloud geometry, as described above in FIG. 9D.

In some embodiments, the encoding, in the bitstream and based on at least one local quality parameter associated with each occupied quality unit, of the point cloud information representing the triangle vertices may further comprise quantizing positions of the triangle vertices. For example, the at least one local quality parameter may include a quantization parameter (e.g., quantization value or scaling factor) for quantizing/dequantizing values used to determine the positions of triangle vertices. The quantization parameter may control how close a reconstructed position of a vertex (after dequantizing) is to the real position of the vertex at the encoder before dequantizing.

In some embodiments, the positions of the triangle vertices may be uniformly quantized.

In some embodiments, positions of the triangle vertices may be quantized if their magnitudes are greater than a threshold.

In some embodiments, the positions of the triangle vertices may be inferred to 0 if their magnitudes are lower than a threshold.

In some embodiments, the decoding, from the bitstream and based on at least one local quality parameter associated with each occupied quality unit, point cloud information representing triangle vertices may comprise dequantizing positions of the triangle vertices.

In some embodiments, the positions of the triangle vertices may be uniformly dequantized.

In some embodiments, the at least one local quality parameter may indicate quantization parameters.

In some embodiments, the at least one local quality parameter may indicate a quantization step of a uniform quantizer.

In some embodiments, the at least one local quality parameter may indicate the threshold.

In some embodiments, the position of triangle vertex may indicate a location of a triangle vertex along an edge of a triangle.

In some embodiments, the position of triangle vertex may indicate a residual vector of a triangle vertex relative to another vertex.

In some embodiments, the another vertex may be based on an average vertex calculated by averaging several vertices.

In some embodiments, the at least one local quality parameter may indicate an activation of a coding of residual vector of a triangle vertex relative to another vertex.

In one embodiment, the at least one local quality parameter may indicate a density of triangle vertices belonging to the occupied quality unit.

In some embodiments, at least one of the triangles constructed from the triangle vertices belonging to each occupied quality unit is replaced (as discussed above) with further triangles derived from the triangle vertices and an additional vertex derived from vertices of at least one of the constructed triangles.

In some embodiments, the at least one triangle constructed from the triangle vertices belonging to an occupied quality unit may be replaced based on satisfying an eligibility criterion. In some embodiments, the eligibility criterion is satisfied when an area of the at least one triangle constructed from the triangle vertices belonging to the occupied quality unit may be higher than a first threshold.

In some embodiments, the local quality information further may indicate the first threshold. In some embodiments, the local quality information may further indicate a sign of the first threshold. In some embodiments, the local quality information may further indicate a magnitude of the first threshold.

In some embodiments, the local quality information may further indicate a null first threshold. In this case, if indicated in the local quality information, the magnitude of the first threshold may further indicate a true magnitude minus 1 because a non-null first threshold is at least 1.

In some embodiments, the eligibility criterion is satisfied when a length of a common edge shared by a pair of adjacent triangles of the at least one triangle constructed from the triangle vertices belonging to the occupied quality unit may be higher than a second threshold.

In some embodiments, the local quality information may further indicate the second threshold. In some embodiments, the local quality information may further indicate a sign of the second threshold. In some embodiments, the local quality information may further indicate a magnitude of the second threshold.

In some embodiments, the local quality information may further indicate a null second threshold. In this case, if indicated in the local quality information, the magnitude of the second threshold may indicate a true magnitude minus 1 because a non-null second threshold is at least 1.

In some embodiments, the first and second thresholds may be known by the decoder beforehand.

In some embodiments, the encoding, in the bitstream, the at least one local quality parameter 1841 associated with a current occupied quality unit may be based on a predictor of the at least one local quality parameter.

In some embodiments, the decoding, from the bitstream, of the at least one local quality parameter 1941 associated with a current occupied quality unit may be based on a predictor of the at least one local quality parameter.

In some embodiments, the point cloud information or local quality information may indicate a predictor of the at least one local quality parameter for the current occupied quality unit.

In some embodiments, the predictor of the at least one local quality parameter may depend on at least one local quality parameter of neighboring already-coded quality units of the current occupied quality unit.

In some embodiments, the neighboring already-coded quality units of the current occupied quality unit may correspond to occupied quality units whose at least one local quality parameter has already been encoded in the bitstream 1890 or decoded from the bitstream 1990.

In some embodiments, the neighboring already-coded quality units may be adjacent to the current occupied quality unit. In some embodiments, the neighboring already-coded quality units may be adjacent to the current occupied quality unit when the neighboring already-coded quality units share a face, an edge and/or a vertex with the current occupied quality unit.

In some embodiments, the predictor of the at least one local quality parameter of the current occupied quality unit may depend on an average of the at least one same local quality parameter of the neighboring already-coded quality units.

In some embodiments, the predictor of the at least one local quality parameter of the current occupied quality unit may depend on a median value of the at least one same local quality parameter of the neighboring already-coded quality units.

In some embodiments, to encode the at least one local quality parameter associated with a current occupied quality unit, residual value of the at least one local quality parameter for the current occupied quality unit is obtained from the predictor of the at least one local quality parameter. Then, the residual value of the at least one local quality parameter for the current occupied quality unit may be encoded in the bitstream.

In some embodiments, the encoding, in the bitstream, the at least one local quality parameter associated with the current occupied quality unit further includes quantizing the residual value of the at least one local quality parameter.

In some embodiments, the encoding, in the bitstream, the at least one local quality parameter associated with the current occupied quality unit further includes entropy coding the quantized residual value of the at least one local quality parameter.

In some embodiments, the residual value of the at least one local quality parameter may be binarized and entropy coded in the bitstream 1190 by a binary entropy coder.

In some embodiments, to decode, from the bitstream, the at least one local quality parameter associated with a current occupied quality unit, a residual value of the at least one local quality parameter for the current occupied quality unit is decoded from the bitstream. Then, the at least one local quality parameter is obtained based on the residual value of the at least one local quality parameter and a predictor of the at least one local quality parameter.

In some embodiments, the local quality information, associated with the current occupied quality unit, may be decoded based on entropy decoding the residual value of the at least one local quality parameter.

In some embodiments, the residual value of the at least one local quality parameter may be entropy decoded by a binary entropy decoder.

In some embodiments, the decoding of the local quality information associated with the current occupied quality unit further includes dequantizing the decoded residual value of the at least one local quality parameter.

In some embodiments, the entropy coding or decoding may use probabilities (e.g., probably model, context, or coder, etc.) to entropy encode/decode the local quality information based on the predictor of the at least one local quality parameter.

In some embodiments, the entropy coding or decoding may be performed by a Context Adaptive Binary Arithmetic Coder (CABAC), in which the contexts are selected based on the predictor of the at least one local quality parameter.

In some embodiments, the residual value of the at least one local quality parameter may be based on a difference between the at least one local quality parameter and the predictor of the at least one local quality parameter.

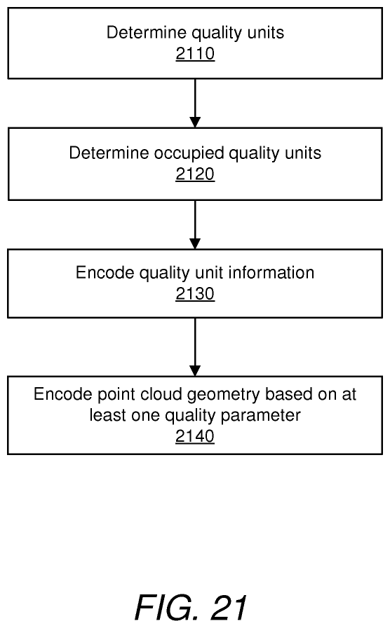

FIG. 21 illustrates a flowchart of an example method for encoding a point cloud geometry into a bitstream, according to some embodiments. For example, the method of FIG. 21 may be performed by an encoder (e.g., encoder 114 of FIG. 1).

At block 2110, quality units that partition a volume encompassing a point cloud geometry are determined.

At block 2120, occupied quality units each containing a portion (e.g., at least a point) of the point cloud geometry are determined from the quality units.

At block 2130, quality unit information, indicating the quality units (that partitioned the volume encompassing the point cloud geometry) and indicating the occupied quality units from the quality units, is encoded in the bitstream.

At block 2140, point cloud information corresponding to a portion of the point cloud geometry contained in each occupied quality unit is encoded in the bitstream. The point cloud information, for the portion of the point cloud geometry, may be encoded based on at least one local quality parameter associated with each occupied quality unit.

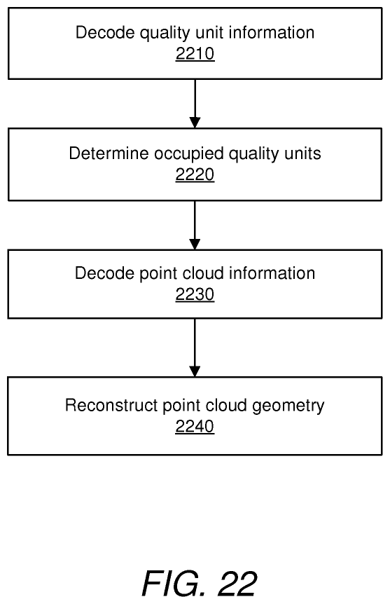

FIG. 22 illustrates a flowchart of an example method for decoding from a bitstream a point cloud geometry, according to some embodiments. For example, the method of FIG. 22 may be performed by a decoder (e.g., decoder 120 of FIG. 1).

At block 2210, quality unit information, indicating quality units that partition a volume encompassing a point cloud geometry, is decoded from the bitstream.

At block 2220, occupied quality units, each containing at least a portion (e.g., at least a point) of the point cloud geometry, are determined based on the decoded quality unit information and from the quality units.

At block 2230, point cloud information, corresponding to a portion of the point cloud geometry contained in each occupied quality unit, is decoded from the bitstream based on at least one local quality parameter associated with each occupied quality unit.

At block 2240, the portion of the point cloud geometry is reconstructed based on the decoded point cloud information. In some embodiments, the portion may be reconstructed further based on the at least one local quality parameter.

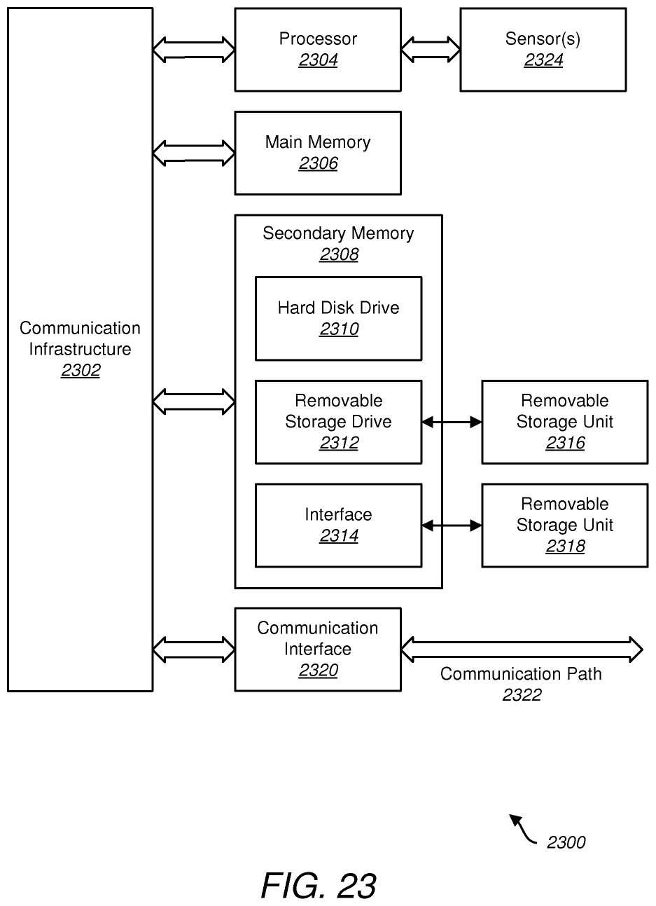

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2300 is shown in FIG. 23. Blocks depicted in the figures above, such as the blocks in FIGS. 1, 6, 10-11, 18-19, and 21-22 may execute on one or more computer systems 2300. Furthermore, each of the steps of the flowcharts depicted in the present disclosure may be implemented on one or more computer systems 2300. When more than one computer system 2300 is used to implement embodiments of the present disclosure, the computer systems 2300 may be interconnected by one or more networks to form a cluster of computer systems that may act as a single pool of seamless resources. The interconnected computer systems 2300 may form a “cloud” of computers.

Computer system 2300 includes one or more processors, such as processor 2304. Processor 2304 may be, for example, a special purpose processor, general purpose processor, microprocessor, or digital signal processor. Processor 2304 may be connected to a communication infrastructure 2302 (for example, a bus or network). Computer system 2300 may also include a main memory 2306, such as random access memory (RAM), and may also include a secondary memory 2308.

Secondary memory 2308 may include, for example, a hard disk drive 2310 and/or a removable storage drive 2312, representing a magnetic tape drive, an optical disk drive, or the like. Removable storage drive 2312 may read from and/or write to a removable storage unit 2316 in a well-known manner. Removable storage unit 2316 represents a magnetic tape, optical disk, or the like, which is read by and written to by removable storage drive 2312. As will be appreciated by persons skilled in the relevant art(s), removable storage unit 2316 includes a computer usable storage medium having stored therein computer software and/or data.

In alternative implementations, secondary memory 2308 may include other similar means for allowing computer programs or other instructions to be loaded into computer system 2300. Such means may include, for example, a removable storage unit 2318 and an interface 2314. Examples of such means may include a program cartridge and cartridge interface (such as that found in video game devices), a removable memory chip (such as an EPROM or PROM) and associated socket, a thumb drive and USB port, and other removable storage units 2318 and interfaces 2314 which allow software and data to be transferred from removable storage unit 2318 to computer system 2300.

Computer system 2300 may also include a communications interface 2320. Communications interface 2320 allows software and data to be transferred between computer system 2300 and external devices. Examples of communications interface 2320 may include a modem, a network interface (such as an Ethernet card), a communications port, etc. Software and data transferred via communications interface 2320 are in the form of signals which may be electronic, electromagnetic, optical, or other signals capable of being received by communications interface 2320. These signals are provided to communications interface 2320 via a communications path 2322. Communications path 2322 carries signals and may be implemented using wire or cable, fiber optics, a phone line, a cellular phone link, an RF link, and other communications channels.

Computer system 2300 may also include one or more sensor(s) 2324. Sensor(s) 2324 may measure or detect one or more physical quantities and convert the measured or detected physical quantities into an electrical signal in digital and/or analog form. For example, sensor(s) 2324 may include an eye tracking sensor to track the eye movement of a user. Based on the eye movement of a user, a display of a point cloud may be updated. In another example, sensor(s) 2324 may include a head tracking sensor to the track the head movement of a user. Based on the head movement of a user, a display of a point cloud may be updated. In yet another example, sensor(s) 2324 may include a camera sensor for taking photographs and/or a 3D scanning device, like a laser scanning, structured light scanning, and/or modulated light scanning device. 3D scanning devices may determine geometry information by moving one or more laser heads, structured light, and/or modulated light cameras relative to the object or scene being scanned. The geometry information may be used to construct a point cloud.

As used herein, the terms “computer program medium” and “computer readable medium” are used to refer to tangible storage media, such as removable storage units 2316 and 2318 or a hard disk installed in hard disk drive 2310. These computer program products are means for providing software to computer system 2300. Computer programs (also called computer control logic) may be stored in main memory 2306 and/or secondary memory 2308. Computer programs may also be received via communications interface 2320. Such computer programs, when executed, enable the computer system 2300 to implement the present disclosure as discussed herein. In particular, the computer programs, when executed, enable processor 2304 to implement the processes of the present disclosure, such as any of the methods described herein. Accordingly, such computer programs represent controllers of the computer system 2350.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

What is claimed is:

1. A method comprising:
decoding, from a bitstream, quality unit information indicating:
an occupancy tree representing a partition of a volume of a point cloud geometry; and
quality units corresponding to nodes of the occupancy tree;
determining, based on the occupancy tree, an occupied quality unit from the quality units, wherein the occupied quality unit contains a portion of the point cloud geometry and corresponds to a set of occupied leaf nodes of the occupancy tree;
decoding, from the bitstream, positions of triangle vertices of the set of occupied leaf nodes;
dequantizing the positions of triangle vertices based on at least one local quality parameter associated with the occupied quality unit; and
reconstructing the portion of the point cloud geometry based on the dequantized positions of triangle vertices.

2. The method of claim 1, wherein reconstructing the portion of the point cloud comprises:
generating triangles from the dequantized positions of triangle vertices; and
voxelizing the triangles to determine voxels representing the portion of the point cloud geometry.

3. The method of claim 1, wherein the quality unit information further indicates a size of the quality units, and wherein the quality units are determined from the nodes of the occupancy tree based on the size.

4. The method of claim 1, wherein the quality unit information indicates a tree level of the occupancy tree, and wherein the occupied quality unit corresponds to the tree level.

5. The method of claim 1, further comprising:
decoding, from the bitstream, respective local quality information for each occupied quality unit of occupied quality units of the quality units, wherein the at least one local quality parameter is decoded from local quality information decoded for the occupied quality unit.

6. The method of claim 1, wherein a position, of a triangle vertex of the triangle vertices, indicates a location of the triangle vertex along an edge of a cuboid corresponding to an occupied leaf node in the set of occupied leaf nodes.

7. The method of claim 1, wherein the at least one local quality parameter comprises a halo parameter or a thickness parameter used to voxelize triangles generated from the triangle vertices.

8. A decoder comprising:
one or more processors; and
memory storing instructions that, when executed by the one or more processors of the decoder, cause the decoder to:
decode, from a bitstream, quality unit information indicating:
an occupancy tree representing a partition of a volume of a point cloud geometry; and
quality units corresponding to nodes of the occupancy tree;
determine, based on the occupancy tree, an occupied quality unit from the quality units, wherein the occupied quality unit contains a portion of the point cloud geometry and corresponds to a set of occupied leaf nodes of the occupancy tree;
decode, from the bitstream, positions of triangle vertices of the set of occupied leaf nodes;
dequantize the positions of triangle vertices based on at least one local quality parameter associated with the occupied quality unit; and
reconstruct the portion of the point cloud geometry based on the dequantized positions of triangle vertices.

9. The decoder of claim 8, wherein to reconstruct the portion of the point cloud, the instructions further cause the decoder to:
generate triangles from the dequantized positions of triangle vertices; and
voxelize the triangles to determine voxels representing the portion of the point cloud geometry.

10. The decoder of claim 8, wherein the quality unit information further indicates a size of the quality units, and wherein the quality units are determined from the nodes of the occupancy tree based on the size.

11. The decoder of claim 8, wherein the quality unit information indicates a tree level of the occupancy tree, and wherein the occupied quality unit corresponds to the tree level.

12. The decoder of claim 8, wherein the instructions further cause the decoder to:
decode, from the bitstream, respective local quality information for each occupied quality unit of occupied quality units of the quality units, wherein the at least one local quality parameter is decoded from local quality information decoded for the occupied quality unit.

13. The decoder of claim 8, wherein a position, of a triangle vertex of the triangle vertices, indicates a location of the triangle vertex along an edge of a cuboid corresponding to an occupied leaf node in the set of occupied leaf nodes.

14. The decoder of claim 8, wherein the at least one local quality parameter comprises a halo parameter or a thickness parameter used to voxelize triangles generated from the triangle vertices.

15. A non-transitory computer-readable medium comprising instructions that, when executed by one or more processors of a decoder, cause the decoder to:
decode, from a bitstream, quality unit information indicating:
an occupancy tree representing a partition of a volume of a point cloud geometry; and
quality units corresponding to nodes of the occupancy tree;
determine, based on the occupancy tree, an occupied quality unit from the quality units, wherein the occupied quality unit contains a portion of the point cloud geometry and corresponds to a set of occupied leaf nodes of the occupancy tree;
decode, from the bitstream, positions of triangle vertices of the set of occupied leaf nodes;
dequantize the positions of triangle vertices based on at least one local quality parameter associated with the occupied quality unit; and
reconstruct the portion of the point cloud geometry based on the dequantized positions of triangle vertices.

16. The non-transitory computer-readable medium of claim 15, wherein to reconstruct the portion of the point cloud, the instructions further cause the decoder to:
generate triangles from the dequantized positions of triangle vertices; and
voxelize the triangles to determine voxels representing the portion of the point cloud geometry.

17. The non-transitory computer-readable medium of claim 15, wherein the quality unit information further indicates a size of the quality units, and wherein the quality units are determined from the nodes of the occupancy tree based on the size.

18. The non-transitory computer-readable medium of claim 15, wherein the quality unit information indicates a tree level of the occupancy tree, and wherein the occupied quality unit corresponds to the tree level.

19. The non-transitory computer-readable medium of claim 15, wherein the instructions further cause the decoder to:
decode, from the bitstream, respective local quality information for each occupied quality unit of occupied quality units of the quality units, wherein the at least one local quality parameter is decoded from local quality information decoded for the occupied quality unit.

20. The non-transitory computer-readable medium of claim 15, wherein the at least one local quality parameter comprises a halo parameter or a thickness parameter used to voxelize triangles generated from the triangle vertices.
